(19) United States
(12) Patent Application Publication
(10) Pub. No.: US 2026/0122598 A1
(43) Pub. Date: Apr. 30, 2026

(54) Positioning Reference Signal (PRS) Frequency Hopping

(71) Applicant: Telefonaktiebolaget LM Ericsson (publ), Stockhom (SE)

(72) Inventors: Zhilan Xiong, Solna (SE); Johan Bergman, Stockholm (SE); Magnus Larsson, Sollentuna (SE)

(21) Appl. No.: 18/873,454

(22) PCT Filed: Jul. 13, 2023
(86) PCT No.: PCT/EP2023/069521

§ 371 Date: Dec. 10, 2024

Related U.S. Application Data
(60) Provisional application No. 63/390,507, filed on Jul. 19, 2022.

(51) Int. Cl. H04W 64/00; H04L 5/00

(52) U.S. Cl. CPC H04W 64/00; H04L 5/0012

(57) ABSTRACT

Embodiments include methods for a user equipment (UE) configured for positioning in a radio access network (RAN). Such methods include receiving, from a positioning node associated with the RAN, a plurality of configurations for positioning reference signals (PRS) transmitted by a corresponding plurality of RAN nodes. Each PRS configuration includes a PRS bandwidth and at least one PRS frequency hopping configuration. Such methods include, for each RAN node, performing positioning measurements on narrowband PRS transmitted by the RAN node within the PRS bandwidth according to the at least one PRS frequency hopping configuration. Such methods include sending the positioning measurements, or information derived therefrom, to the positioning node. Other embodiments include complementary methods for the positioning node and the RAN node, as well as UEs, positioning nodes, and RAN nodes configured to perform such methods.

### TECHNICAL FIELD

The present disclosure relates generally to wireless networks, and more specifically to network transmission of positioning reference signals (PRS) that can be used to determine the geographic location of a user equipment (UE).

### BACKGROUND

Currently the fifth generation (5G) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates an exemplary high-level view of the 5G network architecture, consisting of a Next Generation RAN (NG-RAN) 199 and a 5G Core (5GC) 198. NG-RAN 199 can include a set of gNodeB's (gNBs) connected to the 5GC via one or more NG interfaces, such as gNBs 100, 150 connected via interfaces 102, 152, respectively. In addition, the gNBs can be connected to each other via one or more Xn interfaces, such as Xn interface 140 between gNBs 100 and 150. With respect to the NR interface to UEs, each of the gNBs can support frequency division duplexing (FDD), time division duplexing (TDD), or a combination thereof.

The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a central (or centralized) unit (CU or gNB-CU, e.g., 110) and one or more distributed (or decentralized) units (DU or gNB-DU, e.g., 120 and 130). CUs are logical nodes that host higher-layer protocols and perform various gNB functions such controlling the operation of DUs, which are logical nodes that host lower-layer protocols and can include various subsets of the gNB functions. As such, each of the CUs and DUs can include various circuitry needed to perform their respective functions, including processing circuitry, transceiver circuitry (e.g., for communication), and power supply circuitry.

A gNB-CU connects to gNB-DUs over respective F1 logical interfaces (e.g., 122 and 132 in FIG. 1. The gNB-CU and connected gNB-DUs are only visible to other gNBs and the 5GC as a gNB. In other words, the F1 interface is not visible beyond gNB-CU.

5G/NR technology shares many similarities with fourth generation (4G) Long-Term Evolution (LTE) technology. For example, NR uses CP-OFDM (Cyclic Prefix Orthogonal Frequency Division Multiplexing) in the DL and both CP-OFDM and DFT-spread OFDM (DFT-S-OFDM) in the UL. As another example, in the time domain, NR DL and UL physical resources are organized into equal-sized 1-ms subframes. A subframe is further divided into multiple slots of equal duration, with each slot including multiple OFDM-based symbols. However, time-frequency resources can be configured much more flexibly for an NR cell than for an LTE cell. For example, rather than a fixed 15-kHz OFDM sub-carrier spacing (SCS) as in LTE, NR SCS can range from 15 to 240 kHz, with even greater SCS considered for future NR releases.

In addition to providing coverage via cells as in LTE, NR networks also provide coverage via “beams.” In general, a downlink (DL, i.e., network to UE) “beam” is a coverage area of a network-transmitted reference signal (RS) that may be measured or monitored by a UE. In NR, for example, RS can include any of the following: synchronization signal/PBCH block (SSB), channel state information RS (CSI-RS), tertiary reference signals (or any other sync signal), positioning RS (PRS), demodulation RS (DMRS), phase-tracking RS (PTRS), etc. In general, SSB is available to all UEs regardless of the state of their connection with the network, while other RS (e.g., CSI-RS, DM-RS, PTRS) are associated with specific UEs that have a network connection.

3GPP standards provide various ways for positioning (e.g., determining the position of, locating, and/or determining the location of) UEs operating in NR networks. In general, a positioning node configures a target device (e.g., UE) and/or radio network nodes (RNN, e.g., gNB, ng-eNB, or RNN dedicated for positioning measurements) to perform one or more positioning measurements according to one or more positioning methods. For example, the positioning measurements can include timing (and/or timing difference) measurements on UE, network, and/or satellite transmissions. The positioning measurements are used by the target device, the measuring node, and/or the positioning node to determine the target device's location.

Positioning in NR Rel-16 was developed based on network-transmitted positioning reference signals (PRS), which can enhance location capabilities. For example, PRS transmission in low and high frequency ranges (i.e., FR1 below 6 GHz, FR2 above 6 GHZ) and use of massive antenna arrays provide additional degrees of freedom to substantially improve positioning accuracy. Further enhancements are planned for NR Rel-18, including PRS frequency hopping to improve positioning accuracy for reduced capability (RedCap) UEs that have a maximum bandwidth of 20 MHz (in FR1) and/or 100 MHz (in FR2).

### SUMMARY

PRS frequency hopping is supported by fourth-generation Long Term Evolution machine-type communications (LTE-M) and narrowband Internet-of-Things (NB-IoT) devices with the goal of improved measurement accuracy, but has yet not been introduced to NR positioning techniques such as DL-TDOA and multi-RTT. Furthermore, there are some differences between LTE-M/NB-IoT and NR that make adopting the same PRS frequency hopping solution technically infeasible and/or impractical.

An object of embodiments of the present disclosure is to improve positioning of UEs in a radio access network (RAN) by new techniques for PRS frequency hopping, such as by providing, enabling, and/or facilitating solutions to overcome exemplary problems summarized above and described in more detail below.

Embodiments include methods (e.g., procedures) for a UE configured for positioning in a RAN.

These exemplary methods include receiving, from a positioning node associated with the RAN, a plurality of configurations for PRS transmitted by a corresponding plurality of RAN nodes. Each PRS configuration includes a PRS bandwidth and at least one PRS frequency hopping configuration. These exemplary methods also include, for each RAN node of the plurality of RAN nodes, performing positioning measurements on narrowband PRS transmitted by the RAN node within the PRS bandwidth according to the at least one PRS frequency hopping configuration. These exemplary methods also include sending the positioning measurements, or information derived therefrom, to the positioning node.

In some embodiments, each PRS configuration includes a PRS resource set comprising a plurality of PRS resources and each PRS resource is associated with a different sequence of narrowband PRS transmitted by the RAN node within the PRS bandwidth. In some of these embodiments, each PRS frequency hopping configuration includes one or more of the following parameters associated with the narrowband PRS:
narrowband PRS frequency hopping pattern within the PRS bandwidth;
narrowband PRS bandwidth;
narrowband PRS period;
narrowband PRS long period;
narrowband PRS repetitions;
narrowband PRS duration;
frequency offset of an initial narrowband PRS of the sequence, relative to the start of the PRS bandwidth; and
frequency offset of two closest neighbor PRS frequencies in frequency domain.

For example, the frequency offset of the initial narrowband PRS of the sequence can be given in number of physical resource blocks (PRBs) relative to the start PRB of the PRS bandwidth. As another example, the frequency offset of the two closest neighbor PRS frequencies can be given in number of PRBs.

In some of these embodiments, all PRS resources in the PRS resource set have the same narrowband PRS frequency hopping pattern. In some of these embodiments, each PRS frequency hopping configuration includes the narrowband PRS frequency hopping pattern, which identifies a plurality of sub-bands within the PRS bandwidth. In such embodiments, performing the positioning measurements can include measuring the plurality of sub-bands in a sequence that corresponds to the narrowband PRS frequency hopping pattern.

In some variants of these embodiments, each PRS frequency hopping configuration includes the narrowband PRS period, and each sub-band is measured for a duration that corresponds to the narrowband PRS period. In other variants of these embodiments, each PRS frequency hopping configuration includes a plurality of narrowband PRS durations respectively corresponding to the plurality of sub-bands within the PRS bandwidth, and each sub-band is measured for the corresponding narrowband PRS duration.

In some embodiments, the sequential plurality of sub-bands are non-overlapping in frequency. In other embodiments, one or more pairs of the sub-bands are partially overlapping in frequency and each PRS frequency hopping configuration also indicates an amount or degree of frequency overlap between partially overlapping pairs of sub-bands.

In some of these embodiments, each PRS frequency hopping configuration includes the narrowband PRS repetitions and the sequence of sub-band measurements is repeated a number of times that corresponds to the narrowband PRS repetitions. In some variants of these embodiments, each PRS frequency hopping configuration includes the narrowband long period. After an initial repetition, each subsequent repetition of the sequence of sub-band measurements starts the narrowband long period after the start of a most recent repetition of the sequence.

Other embodiments include methods (e.g., procedures) for a positioning node associated with a RAN.

These exemplary methods include receiving, from a plurality of RAN nodes, a plurality of configurations for PRS transmitted by the respective RAN nodes. Each PRS configuration includes a PRS bandwidth and at least one PRS frequency hopping configuration. These exemplary methods can also include sending the plurality of PRS configurations to a UE served by one of the RAN nodes. These exemplary methods also include receiving from the UE positioning measurements performed by the UE or information derived therefrom. The positioning measurements are of narrowband PRS transmitted by the plurality of RAN nodes within the respective PRS bandwidths according to the respective PRS frequency hopping configurations.

In some embodiments, each PRS configuration includes a PRS resource set comprising a plurality of PRS resources and each PRS resource is associated with a different sequence of narrowband PRS transmitted by the RAN node within the PRS bandwidth. In some of these embodiments, each PRS frequency hopping configuration includes one or more of the following parameters associated with the narrowband PRS:
narrowband PRS frequency hopping pattern within the PRS bandwidth;
narrowband PRS bandwidth;
narrowband PRS period;
narrowband PRS long period;
narrowband PRS repetitions;
narrowband PRS duration;
frequency offset of an initial narrowband PRS of the sequence, relative to the start of the PRS bandwidth; and
frequency offset of two closest neighbor PRS frequencies in frequency domain.
   For example, the frequency offset of the initial narrowband PRS of the sequence can be given in number of PRBs relative to the start PRB of the PRS bandwidth. As another example, the frequency offset of the two closest neighbor PRS frequencies can be given in number of PRBs.

In some of these embodiments, all PRS resources in the PRS resource set have the same narrowband PRS frequency hopping pattern. In some of these embodiments, each PRS frequency hopping configuration includes the narrowband PRS frequency hopping pattern, which identifies a plurality of sub-bands within the PRS bandwidth. In such embodiments, the received positioning measurements or information derived therefrom are based on UE measurements of the plurality of sub-bands in a sequence that corresponds to the narrowband PRS frequency hopping pattern.

In some variants of these embodiments, each PRS frequency hopping configuration includes the narrowband PRS period, and the received positioning measurements or information derived therefrom are based on UE measurement of each individual sub-band for a duration that corresponds to the narrowband PRS period.

In other variants of these embodiments, each PRS frequency hopping configuration includes a plurality of narrowband PRS durations respectively corresponding to the plurality of sub-bands within the PRS bandwidth. The received positioning measurements or information derived therefrom are based on UE measurement of each sub-band for the corresponding narrowband PRS duration.

In some of these embodiments, the sequential plurality of sub-bands are non-overlapping in frequency. In other of these embodiments, one or more pairs of the sub-bands are partially overlapping in frequency and each PRS frequency hopping configuration also indicates an amount or degree of frequency overlap between partially overlapping pairs of sub-bands.

In some of these embodiments, each PRS frequency hopping configuration includes the narrowband PRS repetitions and the received positioning measurements or information derived therefrom are based on the UE repeating the sequence of sub-band measurements a number of times that corresponds to the narrowband PRS repetitions.

In some embodiments, these exemplary methods also include determining a location of the UE based on the received positioning measurements or information derived therefrom.

Other embodiments include methods (e.g., procedures) for a RAN node configured to support positioning of UEs.

These exemplary methods include sending, to a positioning node associated with the RAN, a configuration for PRS transmitted by the RAN node. The PRS configuration includes a PRS bandwidth and at least one PRS frequency hopping configuration. These exemplary methods also include transmitting narrowband PRS within the PRS bandwidth according to the at least one PRS frequency hopping configuration.

In some embodiments, the PRS configuration includes a PRS resource set comprising a plurality of PRS resources and each PRS resource is associated with a different sequence of narrowband PRS transmitted by the RAN node within the PRS bandwidth. In some of these embodiments, each PRS frequency hopping configuration includes one or more of the following parameters associated with the narrowband PRS:
narrowband PRS frequency hopping pattern within the PRS bandwidth;
narrowband PRS bandwidth;
narrowband PRS period;
narrowband PRS long period;
narrowband PRS repetitions;
narrowband PRS duration;
frequency offset of an initial narrowband PRS of the sequence, relative to the start of the PRS bandwidth; and
frequency offset of two closest neighbor PRS frequencies in frequency domain.
   For example, the frequency offset of the initial narrowband PRS of the sequence can be given in number of PRBs relative to the start PRB of the PRS bandwidth. As another example, the frequency offset of the two closest neighbor PRS frequencies can be given in number of PRBs.

In some of these embodiments, all PRS resources in the PRS resource set have the same narrowband PRS frequency hopping pattern. In some of these embodiments, each PRS frequency hopping configuration includes the narrowband PRS frequency hopping pattern, which identifies a plurality of sub-bands within the PRS bandwidth. In such embodiments, the narrowband PRS are transmitted in the plurality of sub-bands in a sequence that corresponds to the narrowband PRS frequency hopping pattern.

In some variants of these embodiments, each PRS frequency hopping configuration includes the narrowband PRS period, and the narrowband PRS are transmitted in each individual sub-band for a duration that corresponds to the narrowband PRS period.

In other variants of these embodiments, each PRS frequency hopping configuration includes a plurality of narrowband PRS durations respectively corresponding to the plurality of sub-bands within the PRS bandwidth. The narrowband PRS are transmitted in each sub-band for the corresponding narrowband PRS duration.

In some of these embodiments, the plurality of sub-bands are non-overlapping in frequency. In other of these embodiments, one or more pairs of the sub-bands are partially overlapping in frequency and the PRS frequency hopping configuration also indicates an amount or degree of frequency overlap between partially overlapping pairs of sub-bands.

In some of these embodiments, each PRS frequency hopping configuration includes the narrowband PRS repetitions and the sequence of narrowband PRS transmissions in the plurality of sub-bands is repeated a number of times that corresponds to the narrowband PRS repetitions. In some variants of these embodiments, each PRS frequency hopping configuration includes the narrowband long period. After an initial repetition, each subsequent repetition of the sequence of narrowband PRS transmissions in the plurality of sub-bands starts the narrowband long period after the start of a most recent repetition of the sequence.

Other embodiments include UEs (e.g., wireless devices, etc.), positioning nodes (e.g., LMFs, E-SMLCs, SUPL nodes, etc.), and RAN nodes (e.g., base stations, eNBs, gNBs, ng-eNBs, TRPs, etc.) configured to perform operations corresponding to any of the exemplary methods described herein. Other embodiments include non-transitory, computer-readable media storing program instructions that, when executed by processing circuitry, configure such UEs, positioning nodes, or RAN nodes to perform operations corresponding to any of the exemplary methods described herein.

These and other embodiments described herein can reduce PRS implementation complexity for both UE and network. Embodiments can also reduce PRS-related signaling between positioning node and RAN nodes, between positioning node and UEs, and/or between RAN nodes and their associated TRPs that transmit PRS. At a high level, embodiments facilitate improved positioning based on frequency hopped PRS, which is beneficial to combat fading often experienced on wireless channels.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 illustrate two high-level views of an exemplary 5G/NR network architecture.

FIG. 3 shows exemplary NR user plane (UP) and control plane (CP) protocol layers.

FIG. 4 is a block diagram illustrating a high-level architecture for UE positioning in NR networks.

FIG. 5 shows a signal flow diagram for an exemplary multi-RTT positioning procedure.

FIGS. 6-9 show exemplary configurations of non-overlapping PRS frequency hopping, according to various embodiments of the present disclosure.

FIGS. 10-11 show exemplary configurations of partially overlapping PRS frequency hopping, according to various embodiments of the present disclosure.

FIG. 12 shows a flow diagram of an exemplary method (e.g., procedure) for a UE, according to various embodiments of the present disclosure.

FIG. 13 shows a flow diagram of an exemplary method (e.g., procedure) for a positioning node (e.g., LMF), according to various embodiments of the present disclosure.

FIG. 14 shows a flow diagram of an exemplary method (e.g., procedure) for a RAN node (e.g., gNB, TRP, etc.), according to various embodiments of the present disclosure.

FIG. 15 shows a communication system according to various embodiments of the present disclosure.

FIG. 16 shows a UE according to various embodiments of the present disclosure.

FIG. 17 shows a network node according to various embodiments of the present disclosure.

FIG. 18 shows a host computing system according to various embodiments of the present disclosure.

FIG. 19 is a block diagram of a virtualization environment in which functions implemented by some embodiments of the present disclosure may be virtualized.

FIG. 20 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node) based on its specific characteristics in any given context.
Positioning measurements: As used herein, “positioning measurements” may include timing measurements (e.g., time difference of arrival, TDOA, RSTD, time of arrival, TOA, Rx-Tx, RTT, etc.), power-based measurements (e.g., RSRP, RSRQ, SINR, etc.), and/or identifier detection/measurement (e.g., cell ID, beam ID, etc.) that are configured for a positioning method (e.g., OTDOA, E-CID, etc.). UE positioning measurements may be reported to a network node or may be used for positioning purposes by the UE.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

FIG. 2 shows another high-level view of an exemplary 5G network architecture, including a NG-RAN (299) and a 5GC (298). The NG-RAN can include gNBs (e.g., 210a,b) and ng-eNBs (e.g., 220a,b) interconnected with each other via respective Xn interfaces. The gNBs and ng-eNBs are also connected via the NG interfaces to the 5GC, more specifically to the Access and Mobility Management Functions (AMFs, e.g., 230a,b) via respective NG-C interfaces and to the User Plane Functions (UPFs, e.g., 240a,b) via respective NG-U interfaces. Moreover, the AMFs can communicate with one or more policy control functions (PCFs, e.g., 250a,b) and network exposure functions (NEFs, e.g., NEFs 260a,b).

Each of the gNBs can support the NR radio interface including frequency division duplexing (FDD), time division duplexing (TDD), or a combination thereof. Each of ng-eNBs can support the fourth generation (4G) Long-Term Evolution (LTE) radio interface. Unlike conventional LTE eNBs, however, ng-eNBs connect to the 5GC via the NG interface. Each of the gNBs and ng-eNBs can serve a geographic coverage area including one or more cells (e.g., 211a-b and 221a-b in FIG. 2). Depending on the cell in which it is located, a UE (205) can communicate with the gNB or ng-eNB serving that cell via the NR or LTE radio interface, respectively. Although FIG. 2 shows gNBs and ng-eNBs separately, it is also possible that a single NG-RAN node provides both types of functionality.

Currently, two NR frequency ranges are defined by 3GPP: FR1 (below 6 GHZ) and FR2 (above 6 GHz). It is known that high-frequency radio communication above 6 GHz suffers from significant path loss and penetration loss. One solution to address this issue is to deploy large-scale antenna arrays to achieve high beamforming gain, which is a reasonable solution due to the small wavelength of high-frequency signal. Such solutions are often called “multiple-input multiple-output” (MIMO) or, in the case of large-scale antenna arrays anticipated for NR, massive MIMO. In particular, up to 64 beams are supported for FR2. In addition, the greater number of antenna elements are likely to be used in FR1 to obtain more beamforming and multiplexing gain.

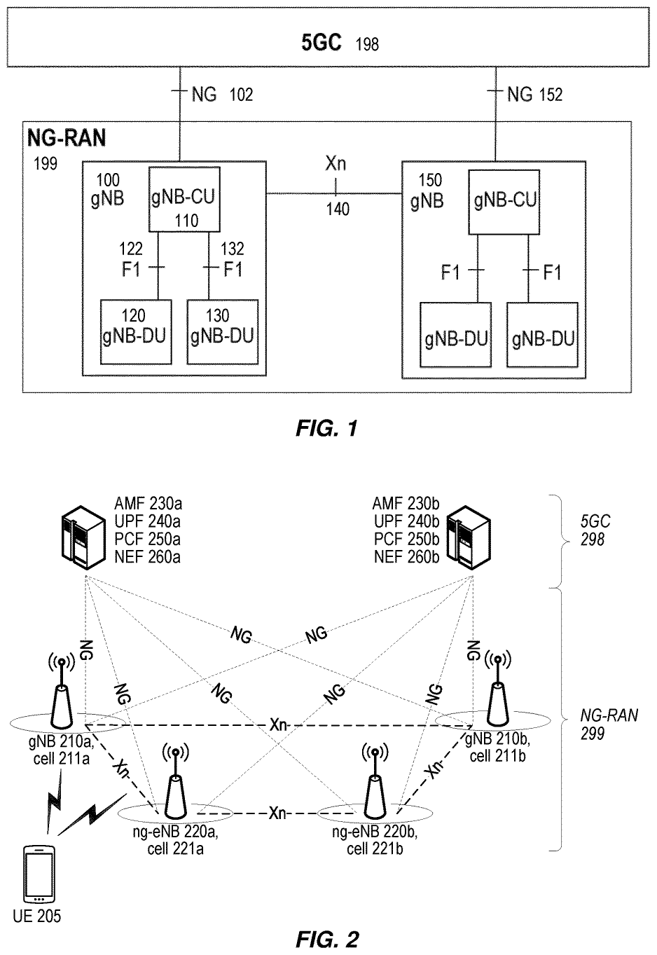

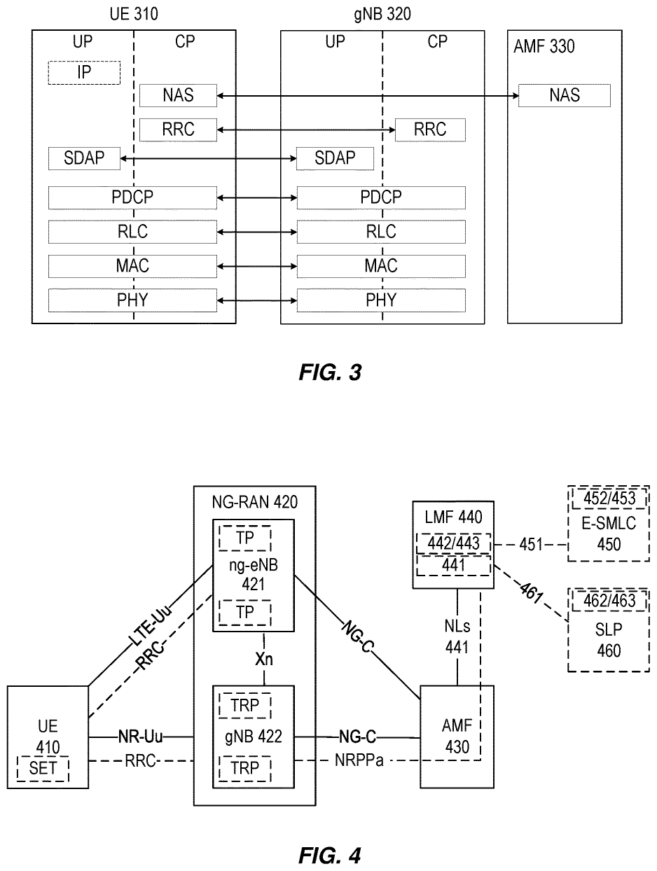

Positioning-related information, such as assistance data and positioning measurements, can be communicated between network and UE via user plane (UP) and control plane (CP). FIG. 3 shows an exemplary configuration of NR UP and CP protocol layers between a UE (310), a gNB (320), and an AMF (330), such as those shown in FIGS. 1-2. The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to PDCP as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. RLC transfers PDCP PDUs to MAC through logical channels (LCH). RLC provides error detection/correction, concatenation, segmentation/reassembly, sequence numbering, reordering of data transferred to/from the upper layers. MAC provides mapping between LCHs and PHY transport channels, LCH prioritization, multiplexing into or demultiplexing from transport blocks (TBs), hybrid ARQ (HARQ) error correction, and dynamic scheduling (on gNB side). PHY provides transport channel services to MAC and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

Three important functional elements of the 3GPP positioning architecture are LCS Client, LCS target, and LCS Server. The LCS Server is a physical or logical entity that manages positioning for an LCS target (e.g., a UE) by collecting measurements and other location information, assisting the LCS target in measurements when necessary, and estimating the LCS target location. An LCS Client is a software and/or hardware entity that interacts with an LCS Server for the purpose of obtaining location information for one or more LCS targets (i.e., the entities being positioned) such as a UE. LCS Clients may also reside in the LCS targets themselves. An LCS Client sends a request to an LCS Server to obtain location information, and the LCS Server processes and serves the received requests and sends the positioning result and optionally a velocity estimate to the LCS Client. A positioning request can be originated from the terminal or a network node or external client. Position calculation can be conducted, for example, by the LCS Server (e.g., E-SMLC or SLP) or by the LCS target (e.g., a UE).

Additionally, the following positioning methods are supported in NR:
Enhanced Cell ID (E-CID). Utilizes information to associate the UE with the geographical area of a serving cell, and then additional information to determine a finer granularity position. The following measurements are supported for E-CID: AoA (base station only), UE Rx-Tx time difference, timing advance (TA) types 1 and 2, reference signal received power (RSRP), and reference signal received quality (RSRQ).
Assisted GNSS. GNSS information retrieved by the UE, supported by assistance information provided to the UE from the E-SMLC.
OTDOA (Observed Time Difference of Arrival). The UE receives and measures Global Navigation Satellite System (GNSS) signals, supported by assistance information provided to the UE from E-SMLC.
UTDOA (Uplink TDOA). The UE is requested to transmit a specific waveform that is detected by multiple location measurement units (LMUs, which may be standalone, co-located or integrated into an eNB) at known positions. These measurements are forwarded to the E-SMLC for multilateration.
Multi-RTT: The device (e.g., UE) computes UE Rx-Tx time difference and gNBs compute gNB Rx-Tx time difference. The results are combined to find the UE position based upon round trip time (RTT) calculation.
DL angle of departure (DL-AoD): gNB or LMF calculates the UE angular position based upon UE DL RSRP measurement results (e.g., of PRS transmitted by RAN nodes).
UL angle of arrival (UL-AoA): gNB calculates the UL AoA based upon measurements of a UE's UL SRS transmissions.

In addition, one or more of the following positioning modes can be utilized in each of the positioning methods listed above:
UE-Assisted: The UE performs measurements with or without assistance from the network and sends these measurements to the E-SMLC where the position calculation may take place.
UE-Based: The UE performs measurements and calculates its own position with assistance from the network.
Standalone: The UE performs measurements and calculates its own position without network assistance.
   The detailed assistance data may include information about network node locations, beam directions, etc. The assistance data can be provided to the UE via unicast or via broadcast.

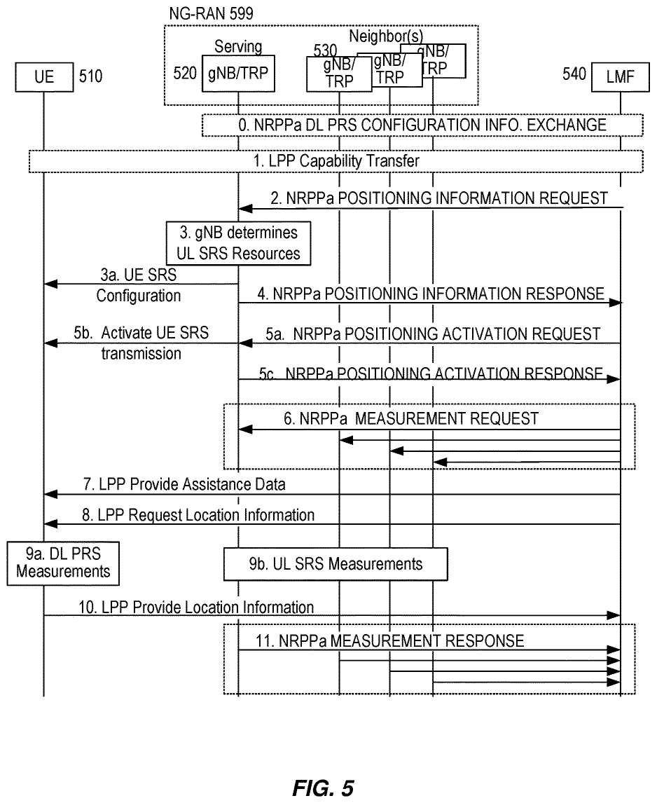

FIG. 4 is a block diagram illustrating a high-level architecture for supporting UE positioning in NR networks. The NG-RAN (420) can include nodes such as gNBs (e.g., 422) and ng-eNBs (e.g., 421), similar to the architecture shown in FIG. 2. Each ng-eNB may control several transmission points (TPs), such as remote radio heads. Similarly, each gNB may control several transmission reception points (TRPs). Some or all of the TPs/TRPs may be DL-PRS-only for support of PRS-based TBS.

In addition, the NG-RAN nodes communicate with an AMF (430) in the 5GC via respective NG-C interfaces (both of which may or may not be present), while the AMF communicates with a location management function (LMF, 440) via an NLs interface (441). LMF supports various functions related to determination of UE locations, including location determination for a UE and obtaining DL location measurements or a location estimate from the UE, UL location measurements from the NG RAN, and non-UE associated assistance data from the NG RAN.

In addition, positioning-related communication between UEs and the NG-RAN nodes occurs via the RRC protocol, while positioning-related communication between NG-RAN nodes and LMFs occurs via an NRPPa protocol. Optionally, the LMF can also communicate with an enhanced serving mobile location center (E-SMLC, 450) and a secure UP location (SUPL) location platform (SLP, 460) via respective communication interfaces (451, 461). These communication interfaces can utilize and/or be based on standardized protocols, proprietary protocols, or a combination thereof. The E-SMLC is responsible for UE positioning via LTE CP while the SLP is responsible for UE positioning via UP.

The LMF can also include, or be associated with, various processing circuitry (442), by which the LMF performs various operations described herein. The LMF processing circuitry can include similar types of processing circuitry as described herein in relation to other network nodes (see, e.g., descriptions of FIGS. 17 and 19). The LMF can also include, or be associated with, a non-transitory computer-readable medium (443) storing instructions (also referred to as a computer program product) that can facilitate the operations of the processing circuitry. The medium can include similar types of computer memory as described herein in relation to other network nodes (see, e.g., descriptions of FIGS. 17 and 19). Additionally, the LMF can include various communication interface circuitry (441, e.g., Ethernet, optical, and/or radio transceivers) that can be used for communication via the NLs interface. For example, the LMF communication interface circuitry can be similar to other communication interface circuitry described herein in relation to other network nodes (see, e.g., descriptions of FIGS. 17 and 19).

Similarly, the E-SMLC can also include, or be associated with, various processing circuitry (452), by which the E-SMLC performs various operations described herein. The E-SMLC processing circuitry can include similar types of processing circuitry as described herein in relation to other network nodes (see, e.g., descriptions of FIGS. 17 and 19). The E-SMLC can also include, or be associated with, a non-transitory computer-readable medium (453) storing instructions (also referred to as a computer program product) that can facilitate the operations of the processing circuitry. The medium can include similar types of computer memory as described herein in relation to other network nodes (see, e.g., descriptions of FIGS. 17 and 19). The E-SMLC can also include communication interface circuitry that is appropriate for communicating via the interface to LMF, which can be similar to other communication interface circuitry described herein in relation to other network nodes (see, e.g., descriptions of FIGS. 17 and 19).

Similarly, the SLP can also include, or be associated with, various processing circuitry (462), by which the SLP performs various operations described herein. The SLP processing circuitry can include similar types of processing circuitry as described herein in relation to other network nodes (see, e.g., descriptions of FIGS. 17 and 19). The SLP can also include, or be associated with, a non-transitory computer-readable medium (463) storing instructions (also referred to as a computer program product) that can facilitate the operations of the processing circuitry. The medium can include similar types of computer memory as described herein in relation to other network nodes (see, e.g., descriptions of FIGS. 17 and 19). The SLP can also include communication interface circuitry that is appropriate for communicating via the interface to LMF, which can be similar to other communication interface circuitry described herein in relation to other network nodes (see, e.g., descriptions of FIGS. 17 and 19).

In typical operation, the AMF can receive a request for a location service associated with a particular target UE from another entity (e.g., a gateway mobile location center, GMLC), or the AMF itself can initiate some location service on behalf of a particular target UE (e.g., for an emergency call from the UE). The AMF then sends a location services (LS) request to the LMF. The LMF processes the LS request, which may include transferring assistance data to the target UE (i.e., to assist with UE-based and/or UE-assisted positioning) and/or determining the location of the target UE. The LMF then returns the result of these operations (e.g., a position estimate for the UE and/or an indication of any assistance data transferred to the UE) to the AMF or to another entity (e.g., GMLC) that requested the LS.

Various interfaces and protocols are used for, or involved in, NR positioning. The LTE Positioning Protocol (LPP) is used between a target device (e.g., UE in the control-plane, or SET in the user-plane) and a positioning server (e.g., LMF in the control-plane, SLP in the user-plane). LPP can use either CP or UP protocols as underlying transport. NRPP is terminated between a target device and the LMF. RRC protocol is used between UE and gNB (via NR radio interface) and between UE and ng-eNB (via LTE radio interface).

Furthermore, the NR Positioning Protocol A (NRPPa) carries information between the NG-RAN Node and the LMF and is transparent to the AMF. As such, the AMF routes the NRPPa PDUs transparently (e.g., without knowledge of the involved NRPPa transaction) over NG-C interface based on a Routing ID corresponding to the involved LMF. More specifically, the AMF carries the NRPPa PDUs over NG-C interface either in UE associated mode or non-UE associated mode. The NGAP protocol between the AMF and an NG-RAN node (e.g., gNB or ng-eNB) is used as transport for LPP and NRPPa messages over the NG-C interface. NGAP is also used to instigate and terminate NG-RAN-related positioning procedures.

LPP/NRPP are used to deliver messages such as positioning capability request, OTDOA positioning measurements request, and OTDOA assistance data to the UE from a positioning node (e.g., LMF). LPP/NRPP are also used to deliver messages from the UE to the positioning node including, e.g., UE capability, UE measurements for UE-assisted OTDOA positioning, UE request for additional assistance data, UE configuration parameter(s) to be used to create UE-specific OTDOA assistance data, etc. NRPPa is used to deliver the information between ng-eNB/gNB and LMF in both directions. This can include LMF requesting some information from ng-eNB/gNB, and ng-eNB/gNB providing some information to LMF. For example, this can include information about PRS transmitted by ng-eNB/gNB that are to be used for OTDOA positioning measurements by the UE.

PRS were introduced in LTE Rel-9 because cell-specific reference signals (CRS) were not sufficient for positioning. In particular, CRS could not guarantee the necessary probability of detection for at least three different cells needed to determine a position. In general, a neighbor cell's synchronization signals (PSS/SSS) and reference signals are generally detectable for signal-to-interference-and-noise ratio (SINR)≥−6 dB. Simulations have shown, however, that this SINR is available for the third-best detected cell in ≤70% of all cases, such that only two neighbor cells are detected in ≥30% of cases. Even this level of performance is based on an interference-free environment, which is unrealistic in a real-world scenario.

Even so, PRS have some similarities with CRS. For example, PRS is a pseudo-random QPSK sequence that is mapped in diagonal patterns with shifts in frequency and time to avoid collision with CRS and an overlap with the control channels (PDCCH).

FIG. 5 shows a signal flow diagram for an exemplary multi-RTT positioning procedure between a UE (510), an NG-RAN (599) including a serving gNB/TRP (520) and a plurality of neighbor gNBs/TRPs (including 530), and an LMF (540). In this procedure, the UE measures DL PRS transmitted by the respective gNBs/TRPs (operation 9a), which also measure UL SRS transmitted by the UE (operation 9b). The UE provides the DL PRS measurements to the LMF in an LPP Provide Location Information message (operation 10), and the gNBs/TRPs provide the UL SRS measurements to the LMF in an NRPPa Measurement Response message (operation 11). The LMF may use either or both of these measurements to determine the UE's position. 3GPP TS 38.305 (v17.1.0) section 8.10.4 describes further details of the procedure shown in FIG. 5.

Narrowband Internet of Things (NB-IoT) is a low-power, wide-area network (LPWAN) radio technology standard developed by 3GPP for cellular devices and services. The specification was initially developed for LTE Rel-13 and extended for LTE Rel-14. NB-IoT focuses specifically on indoor coverage, low cost, long battery life, and high connection density. NB-IoT uses a subset of LTE technology and limits the bandwidth to a single narrow-band of 200 kHz.

LTE Machine Type Communication (LTE-M) is a different LPWAN radio technology standard developed by 3GPP to enable a wider range of cellular devices and services, specifically for machine-to-machine (M2M) and IoT applications. The specification was initially developed in LTE Rel-13 and extended in LTE Rel-14. Advantages of LTE-M over NB-IoT include higher data rate, mobility, and voice support, but at the expense of increased bandwidth.

PRS frequency hopping is supported by LTE-M and NB-IoT devices due to improved measurement accuracy. In LTE-M, PRS of one transmit point (TP) can hop between sub-bands within a set of 2 or 4 sub-bands but the different sub-bands share the same PRS resource configuration. In NB-IoT, narrowband PRS (NPRS) resources are configured separately and/or independently for each band. In particular, each band has its own NPRS resource configuration, either the same NPRS subframe pattern or the same NPRS periodicity, number of NPRS subframes in one occasion, starting subframe offset, and NPRS muting configuration. In general, to improve PRS measurement performance, the UE should measure as many different carrier frequencies as possible and consecutive PRS measurements should be separated as far as possible in frequency.

In NR DL-TDOA and multi-RTT positioning methods, the PRS configuration for one TRP includes up to eight (8) PRS resource sets and each PRS resource set includes up to 64 PRS resources. Each PRS resource set has its own subcarrier spacing (SCS), PRS bandwidth, frequency and start PRB indication, comb size, cyclic prefix (CP) type, resource set periodicity, resource set slot offset, resource repetition factor, resource time gap, resource number of symbols, PRS muting pattern and transmit power. Each PRS resource has its own sequence ID, RE offset, slot offset, and resource symbol offset. In a typical network implementation, each PRS resource set corresponds to a TRP in one frequency and each PRS resource in a PRS resource set corresponds to a beam transmitted by the TRP.

Table 1 below describes an exemplary data structure for a PRS Resource Set List information element (IE), which includes one or more PRS Resource Set items (each of which specifies a PRS Resource Set). Further details are provided in 3GPP TS 38.455 (v17.1.0). As illustrated in Table 1, NR PRS Resource Set configurations do not include frequency hopping.

TABLE 1

| | | | | Semantics |
|---|---|---|---|---|
| IE/Group Name | Pres. | Range | IE Type/Ref. | Description |
| PRS Resource Set List | | 1 | | |
| >PRS Resource Set | | 1 . . . <maxnoofPRSresourceSet> | | |
| Item | | | | |
| >>PRS Resource Set | M | | INTEGER(0 . . . 7) | |
| ID | | | | |
| >>Subcarrier Spacing | M | | ENUMERATED | |
| | | | (kHz 15, kHz 30, | |
| | | | kHz 60, kHz 120, . . . ) | |
| >>PRS bandwidth | M | | INTEGER (1 . . . 63) | 24, 28, . . . , |
| | | | | 272 PRBs |
| >>Start PRB | M | | INTEGER (0 . . . 2176) | Starting PRB to |
| | | | | Point A |
| >>Point A | M | | INTEGER | NR ARFCN |
| | | | (0 . . . 3279165) | |
| >>Comb Size | M | | ENUMERATED (2, 4, | |
| | | | 6, 12, . . . ) | |
| >>CP Type | M | | ENUMERATED | |
| | | | (normal, extended, . . . ) | |
| >>Resource Set | M | | ENUMERATED | |
| Periodicity | | | (4, 5, 8, 10, 16, 20, 32, | |
| | | | 40, 64, 80, 160, 320, 640, | |
| | | | 1280, 2560, 5120, 10240, | |
| | | | 20480, 40960, 81920, . . . ) | |
| >>Resource Set Slot | M | | INTEGER | |
| Offset | | | (0 . . . 81919, . . . ) | |
| >>Resource Repetition | M | | ENUMERATED | |
| Factor | | | (rf1, rf2, rf4, rf6, rf8, | |
| | | | rf16, rf32, . . . ) | |
| >>Resource Time Gap | M | | ENUMERATED | |
| | | | (tg1, tg2, tg4, tg8, tg16, | |
| | | | tg32, . . . ) | |
| >>Resource Number of | M | | ENUMERATED | |
| Symbols | | | (n2, n4, n6, n12, . . . ) | |
| >>PRS Muting | O | | | |
| >>> Option 1 | O | | | |
| >>>>Muting Pattern | M | | DL-PRS Muting | Muting pattern |
| | | | Pattern 9.2.56 | option 1 is used to |
| | | | | mute the whole |
| | | | | PRS resource set |
| | | | | (within a period) |
| >>>>Muting Bit | M | | ENUMERATED | |
| Repetition Factor | | | (1, 2, 4, 8, . . . ) | |
| >>> Option2 | O | | | |
| >>>>Muting Pattern | M | | DL-PRS Muting | Muting pattern |
| | | | Pattern 9.2.56 | option 2 is used to |
| | | | | mute the selected |
| | | | | repetition of the |
| | | | | resource set |
| | | | | (within the period) |
| >>PRS Resource | M | | INTEGER(−60 . . . 50) | |
| Transmit Power | | | | |
| >>PRS Resource List | | 1 | | NR-DL-PRS- |
| | | | | Resource-r16 as |
| | | | | defined in TS |
| | | | | 37.355 [14] |
| >>>PRS Resource | | 1 . . . <maxnoofPRSresources> | | |
| Item | | | | |
| >>>>PRS Resource | M | | INTEGER (0 . . . 63) | |
| ID | | | | |
| >>>>Sequence ID | M | | INTEGER (0 . . . 4095) | |
| >>>>RE Offset | M | | INTEGER (0 . . . 11, . . . ) | |
| >>>>Resource Slot | M | | INTEGER (0 . . . 511) | |
| Offset | | | | |
| >>>>Resource | M | | INTEGER (0 . . . 12) | |
| Symbol Offset | | | | |
| >>>>CHOICE QCL | O | | | |
| Info | | | | |
| >>>>>SSB | | | | |
| >>>>>>NR PCI | M | | INTEGER (0 . . . 1007) | |
| >>>>>> SSB | O | | INTEGER (0 . . . 63) | |
| Index | | | | |
| >>>>>DL-PRS | | | | |
| >>>>>>QCL | M | | INTEGER (0 . . . 7) | |
| Source PRS | | | | |
| Resource Set ID | | | | |
| >>>>>>QCL | O | | INTEGER (0 . . . 63) | If it is absent, the |
| Source PRS | | | | QCL source PRS |
| Resource ID | | | | resource ID is the |
| | | | | same as the PRS |
| | | | | resource ID |

Other positioning-related enhancements are planned for NR Rel-18, including PRS frequency hopping to improve positioning accuracy for reduced capability (RedCap) UEs that have a maximum bandwidth of 20 MHz (in FR1) and/or 100 MHz (in FR2). However, there are some differences between LTE-M/NB-IoT and NR that make adopting the same PRS frequency hopping solution technically infeasible and/or impractical. For example, NR can use much wider bandwidths than LTE-M/NB-IoT.

Accordingly, embodiments of the present disclosure provide flexible and efficient techniques for UEs, RAN nodes (e.g., gNBs/TRPs), and positioning nodes (e.g., LMFs) to support PRS frequency hopping for wideband positioning (e.g., for NR). In some embodiments, all beams transmitted by a TRP have the same PRS frequency hopping pattern. The granularity in frequency domain could be at least one PRB. In some embodiments, all PRS resources of one PRS resource set have the same PRS frequency hopping pattern. In some embodiments, each PRS resource set in a PRS configuration is associated with a corresponding PRS frequency hopping pattern and all PRS resources within the same PRS resource set have the same PRS frequency hopping pattern.

Embodiments can reduce PRS implementation complexity for UEs and RAN, and can reduce PRS-related signaling between positioning node and RAN nodes, between positioning node and UEs, and/or between RAN nodes and their associated TRPs that transmit PRS. At a high level, embodiments facilitate improved positioning based on frequency hopped PRS, which is beneficial to combat frequency-selective fading often experienced in wireless channels.

Embodiments are described below based on an exemplary arrangement of a UE, a first RAN node serving the area in which the UE operates, a second RAN node that serves a neighboring area, and a positioning node. For example, the first RAN node can be the serving gNB/TRP, the second RAN node can be a neighbor gNB/TRP, and the positioning node can be the LMF shown in FIG. 5.

Similar to the arrangement shown in FIG. 5, the positioning node collects PRS configurations of the first and second RAN nodes. Each PRS configuration includes a configuration for PRS frequency hopping, such as described below. The positioning node provides these PRS configurations to the UE, which measures the PRS transmitted by the first and second RAN nodes (or associated TRPs) according to the PRS configurations. This can include measurements for received signal time difference (RSTD) for DL-TDOA positioning and/or time of arrival (TOA) for multi-RTT positioning. The UE provides the PRS measurements to the positioning node, which can use these measurements to determine the UE's location.

At a high level, embodiments can be separated into two categories: non-overlapping PRS frequency hopping and partially overlapping PRS frequency hopping. These are described in more detail below.

In various embodiments, a configuration of non-overlapping PRS frequency hopping can include one or more of the following:
narrowband PRS frequency hopping (FH) pattern;
narrowband PRS bandwidth;
narrowband PRS period;
narrowband PRS long period;
narrowband PRS repetitions (i.e., number of repetitions of PRS long period);
narrowband PRS duration; and
physical resource block (PRB) offset of the first narrowband of narrowband PRS relative to start PRB of full PRS bandwidth.

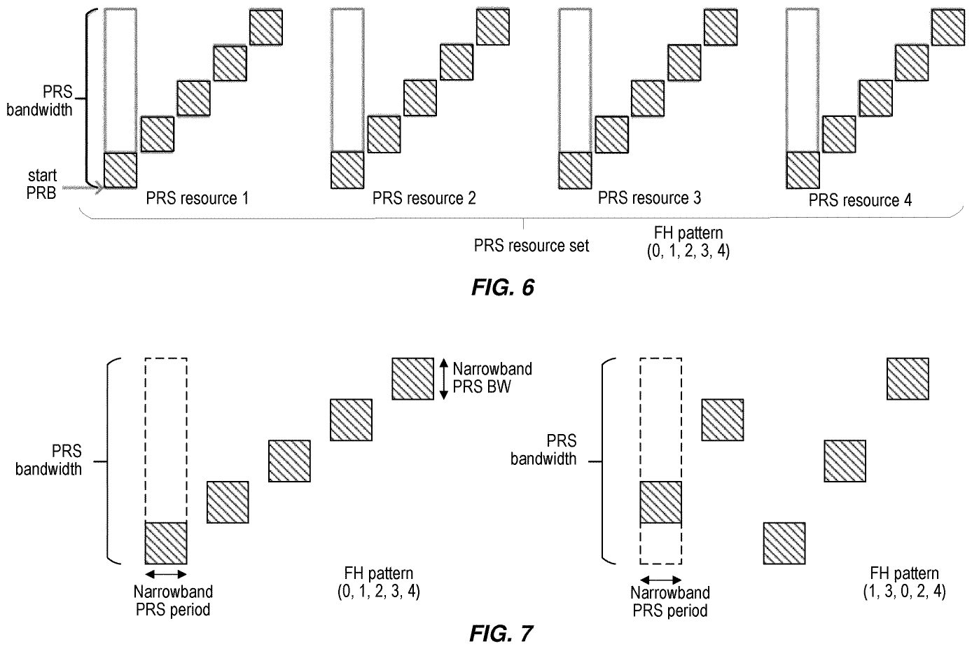

FIG. 6 shows an exemplary configuration of non-overlapping PRS frequency hopping according to some embodiments of the present disclosure. In this configuration, a PRS resource set includes four PRS resources, labelled 1-4. Each PRS resource has the same start PRB, the same bandwidth spanning five PRS narrowbands (0-4), and the same FH pattern (0, 1, 2, 3, 4) across the PRS narrowbands. For example, the PRS resource set can correspond to one TRP and the PRS resources can correspond to respective beams transmitted by the TRP, each using the same PRS frequency hopping configuration.

FIG. 7 shows two exemplary configurations of non-overlapping PRS frequency hopping within a PRS resource, according to other embodiments of the present disclosure. The left-most PRS resource has the same PRS FH pattern (0, 1, 2, 3, 4) across the five PRS narrowbands spanning the full PRS bandwidth, as each PRS resource shown in FIG. 6. The right-most PRS resource has the same full PRS bandwidth comprising five PRS narrowbands, but a different FH pattern (1, 3, 0, 2, 4) across the PRS narrowbands. In both configurations shown in FIG. 7, all five narrowband PRS have the same narrowband PRS period and the same narrowband PRS bandwidth.

FIG. 8 shows two exemplary configurations of non-overlapping PRS frequency hopping within a PRS resource, according to other embodiments of the present disclosure. The two configurations shown in FIG. 8 are similar to corresponding configurations shown in FIG. 7, with the primary difference being that durations of respective narrowband PRS repetitions within a pattern are configured individually. For example, duration (0) corresponds to the duration (e.g., in symbols or slots) of the PRS transmitted in narrowband 0, duration (1) corresponds to the duration of the PRS transmitted in narrowband 1, etc.

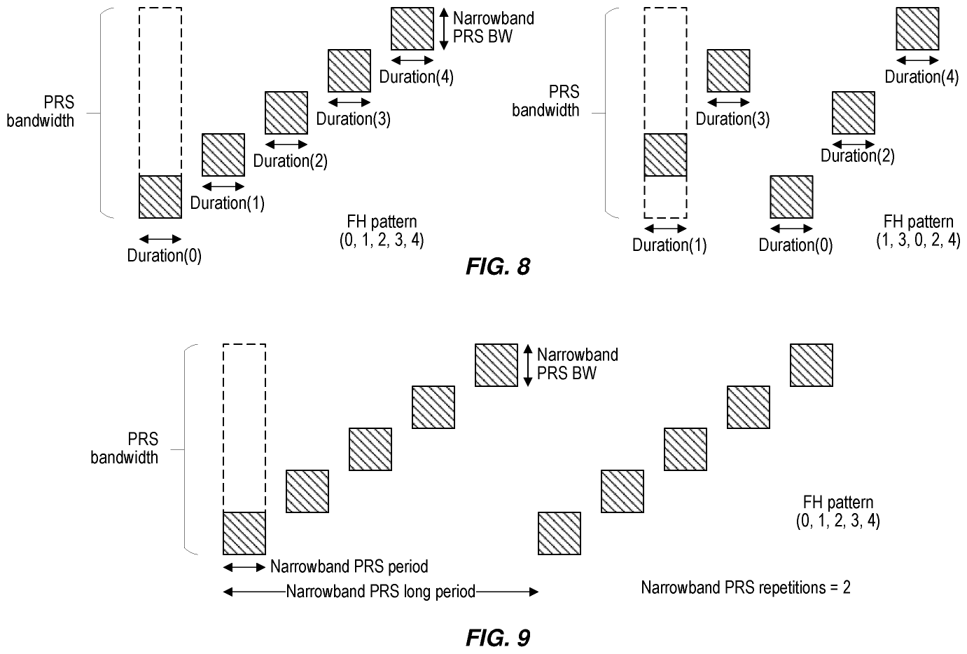

FIG. 9 shows an exemplary configuration of non-overlapping PRS frequency hopping within a PRS resource, according to other embodiments of the present disclosure. The configuration in FIG. 9 includes a common narrowband PRS period similar to FIG. 7, but also includes a narrowband PRS long period that specifies the duration of the FH pattern and a narrowband PRS repetitions parameter that specifies the number of repetitions of the FH pattern (e.g., 2 in this case).

In various embodiments, a configuration of partially overlapping PRS frequency hopping can include one or more of the following:
narrowband PRS FH pattern;
narrowband PRS bandwidth;
narrowband PRS period;
narrowband PRS long period;
narrowband PRS repetitions (i.e., number of repetitions of PRS long period);
narrowband PRS duration;
PRB offset of the first narrowband of narrowband PRS relative to start PRB of full PRS bandwidth; and
PRB offset of two closest neighbor PRS frequencies in frequency domain, which is an additional option compared to non-overlapping PRS frequency hopping configurations.

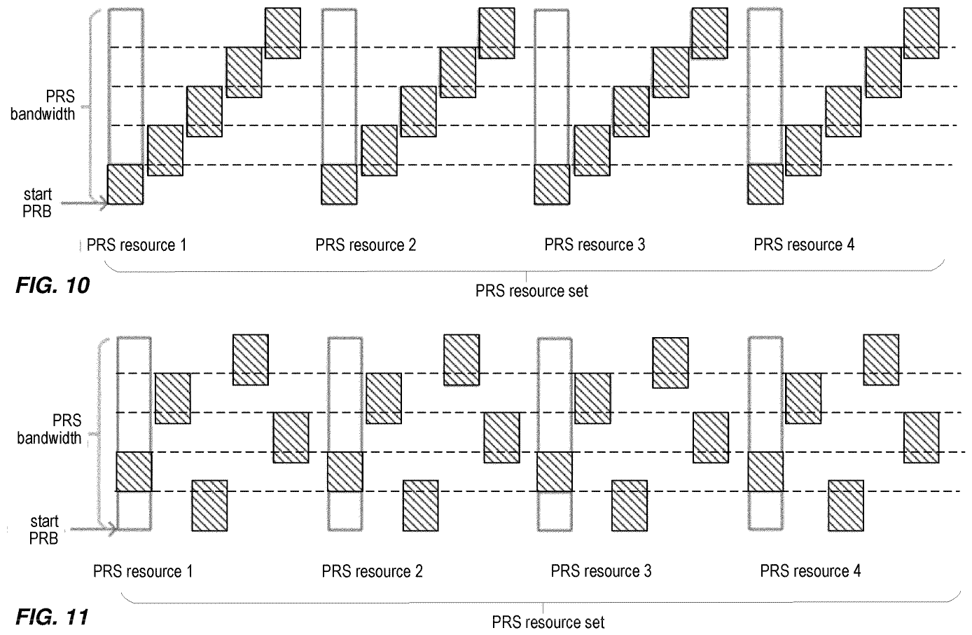

FIG. 10 shows an exemplary configuration of partially overlapping PRS frequency hopping, according to other embodiments of the present disclosure. In this configuration, a PRS resource set includes four PRS resources, labelled 1-4. Similar to the arrangement shown in FIG. 6, each PRS resource has the same start PRB, the same bandwidth, and the same FH pattern (0, 1, 2, 3, 4) across the PRS narrowbands.

One difference from FIG. 6 is that the configuration shown in FIG. 10 includes partial frequency overlap between successive narrowband PRS transmissions in the FH pattern. The amount of overlap can be configured by the PRB offset of two closest neighbor PRS frequencies in frequency domain parameter listed above. The dashed lines illustrate the equal division of the PRS bandwidth and the larger bandwidths of certain narrowband PRS transmissions. One benefit of partial frequency overlapping is to mitigate the potential impact of phase rotation due to different carrier frequencies.

FIG. 11 shows another exemplary configuration of partially overlapping PRS frequency hopping, according to other embodiments of the present disclosure. This configuration is similar to the one shown in FIG. 10 except for a different FH pattern (1, 3, 0, 2, 4) and some resulting differences in frequency overlap.

Similar to the PRS resource set shown in FIG. 6, each of the PRS resource sets shown in FIGS. 10-11 can corresponds to one TRP and the PRS resources can correspond to respective beams transmitted by the TRP, each using the same PRS FH configuration. The arrangements shown in FIGS. 6 and 10-11 are only exemplary, however, and the respective PRS resources within a PRS resource set can also have individualized FH configurations as needed or desired.

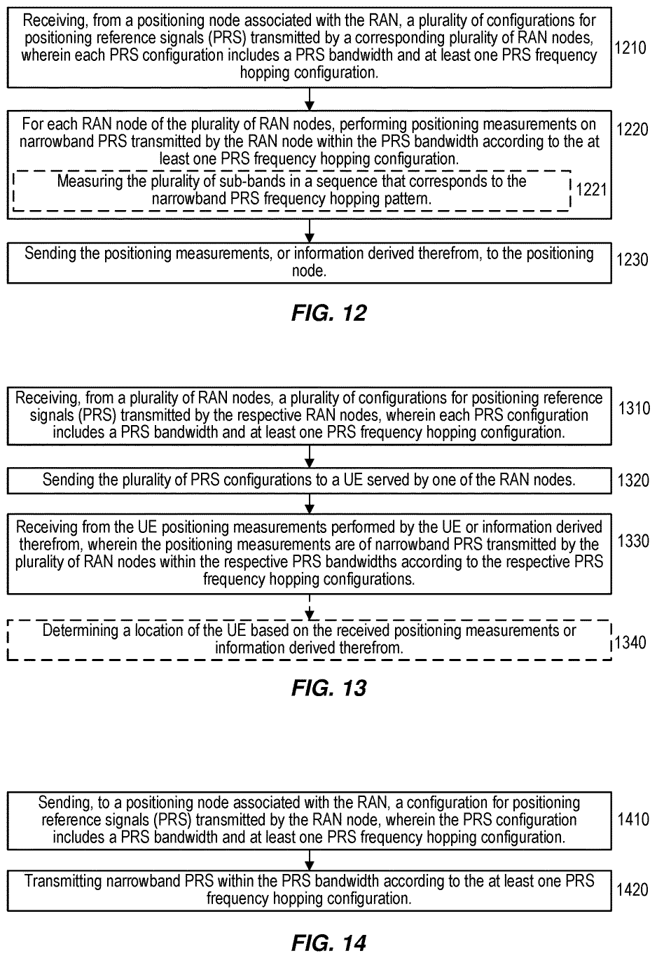

Various features of the embodiments described above correspond to various operations shown in FIGS. 12-14, which depict exemplary methods (e.g., procedures) for a UE, a positioning node, and a RAN node, respectively. In other words, various features of the operations described below correspond to various embodiments described above. Furthermore, the exemplary methods shown in FIGS. 12-14 can be used cooperatively to provide various benefits, advantages, and/or solutions to problems described herein. Although FIGS. 12-14 show specific blocks in particular orders, the operations of the exemplary methods can be performed in different orders than shown and can be combined and/or divided into blocks having different functionality than shown. Optional blocks or operations are indicated by dashed lines.

In particular, FIG. 12 shows an exemplary method (e.g., procedure) for a UE configured for positioning in a RAN, according to various embodiments of the present disclosure. The exemplary method can be performed by a UE (e.g., wireless device, etc.) such as described elsewhere herein.

The exemplary method can include the operations of block 1210, where the UE can receive, from a positioning node associated with the RAN, a plurality of configurations for PRS transmitted by a corresponding plurality of RAN nodes (i.e., one configuration per RAN node). Each PRS configuration includes a PRS bandwidth and at least one PRS frequency hopping configuration. For example, the positioning node can be an LMF.

The exemplary method can also include the operations of block 1220, where for each RAN node of the plurality of RAN nodes, the UE can perform positioning measurements on narrowband PRS transmitted by the RAN node within the PRS bandwidth according to the at least one PRS frequency hopping configuration. The exemplary method can also include the operations of block 1230, where the UE can send the positioning measurements, or information derived therefrom, to the positioning node.

In some embodiments, each PRS configuration includes a PRS resource set comprising a plurality of PRS resources and each PRS resource includes or is associated with a different sequence of narrowband PRS transmitted by the RAN node within the PRS bandwidth. For example, the positioning measurements are performed (e.g., in block 1220) on the narrowband PRS transmitted in the PRS resources. In some of these embodiments, each PRS frequency hopping configuration includes one or more of the following parameters associated with the narrowband PRS:
narrowband PRS frequency hopping pattern within the PRS bandwidth;
narrowband PRS bandwidth;
narrowband PRS period;
narrowband PRS long period;
narrowband PRS repetitions;
narrowband PRS duration;
frequency offset of an initial narrowband PRS of the sequence, relative to the start of the PRS bandwidth; and
frequency offset of two closest neighbor PRS frequencies in frequency domain.
   For example, the frequency offset of the initial narrowband PRS of the sequence can be given in number of physical resource blocks (PRBs) relative to the start PRB of the PRS bandwidth. As another example, the frequency offset of the two closest neighbor PRS frequencies can be given in number of PRBs.

In some of these embodiments, all PRS resources in the PRS resource set have the same narrowband PRS frequency hopping pattern. FIGS. 6 and 10-11 show examples of these embodiments. In some embodiments, each PRS frequency hopping configuration includes the narrowband PRS frequency hopping pattern, which identifies a plurality of sub-bands within the PRS bandwidth. In such embodiments, performing the positioning measurements in block 1220 can include the operations of sub-block 1221, where the UE can measure the plurality of sub-bands in a sequence that corresponds to the narrowband PRS frequency hopping pattern.

In some variants of these embodiments, each PRS frequency hopping configuration includes the narrowband PRS period, and each sub-band is measured for a duration that corresponds to the narrowband PRS period. FIG. 7 shows an example of these embodiments.

In other variants of these embodiments, each PRS frequency hopping configuration includes a plurality of narrowband PRS durations respectively corresponding to the plurality of sub-bands within the PRS bandwidth, and each sub-band is measured for the corresponding narrowband PRS duration. FIG. 8 shows an example of these embodiments.

In some of these embodiments, the plurality of sub-bands are non-overlapping in frequency. FIGS. 6-9 show examples of these embodiments. In other of these embodiments, one or more pairs of sub-bands (i.e., among the plurality sub-bands) are partially overlapping in frequency and each PRS frequency hopping configuration also indicates an amount or degree of frequency overlap between partially overlapping pairs of sub-bands. FIGS. 10-11 show examples of these embodiments.

In some of these embodiments, each PRS frequency hopping configuration includes the narrowband PRS repetitions and the sequence of sub-band measurements is repeated a number of times that corresponds to the narrowband PRS repetitions. In some variants of these embodiments, each PRS frequency hopping configuration includes the narrowband long period. After an initial repetition, each subsequent repetition of the sequence of sub-band measurements starts the narrowband long period after the start of a most recent repetition of the sequence. FIG. 9 shows an example of these embodiments and variants.

In addition, FIG. 13 shows an exemplary method (e.g., procedure) for a positioning node associated with a RAN, according to various embodiments of the present disclosure. The exemplary method can be performed by a positioning node (e.g., LMF, E-SMLC, SUPL, etc.) such as described elsewhere herein.

The exemplary method can include the operations of block 1310, where the positioning node can receive, from a plurality of RAN nodes, a plurality of configurations for PRS transmitted by the respective RAN nodes (i.e., one configuration per RAN node). Each PRS configuration includes a PRS bandwidth and at least one PRS frequency hopping configuration. The exemplary method can also include the operations of block 1320, where the positioning node can send the plurality of PRS configurations to a UE served by one of the RAN nodes. The exemplary method can also include the operations of block 1330, where the positioning node can receive from the UE positioning measurements performed by the UE or information derived therefrom. The positioning measurements are of narrowband PRS transmitted by the plurality of RAN nodes within the respective PRS bandwidths according to the respective PRS frequency hopping configurations.

In some embodiments, each PRS configuration includes a PRS resource set comprising a plurality of PRS resources and each PRS resource includes or is associated with a different sequence of narrowband PRS transmitted by the RAN node within the PRS bandwidth. For example, the positioning measurements are performed by the UE on the narrowband PRS transmitted in the PRS resources. In some of these embodiments, each PRS frequency hopping configuration includes one or more of the following parameters associated with the narrowband PRS:
narrowband PRS frequency hopping pattern within the PRS bandwidth;
narrowband PRS bandwidth;
narrowband PRS period;
narrowband PRS long period;
narrowband PRS repetitions;
narrowband PRS duration;
frequency offset of an initial narrowband PRS of the sequence, relative to the start of the PRS bandwidth; and
frequency offset of two closest neighbor PRS frequencies in frequency domain.
   For example, the frequency offset of the initial narrowband PRS of the sequence can be given in number of physical resource blocks (PRBs) relative to the start PRB of the PRS bandwidth. As another example, the frequency offset of the two closest neighbor PRS frequencies can be given in number of PRBs.

In some of these embodiments, all PRS resources in the PRS resource set have the same narrowband PRS frequency hopping pattern. FIGS. 6 and 10-11 show examples of these embodiments. In some of these embodiments, each PRS frequency hopping configuration includes the narrowband PRS frequency hopping pattern, which identifies a plurality of sub-bands within the PRS bandwidth. In such embodiments, the received positioning measurements or information derived therefrom are based on UE measurements of the plurality of sub-bands in a sequence that corresponds to the narrowband PRS frequency hopping pattern.

In some variants of these embodiments, each PRS frequency hopping configuration includes the narrowband PRS period, and the received positioning measurements or information derived therefrom are based on UE measurement of each sub-band for a duration that corresponds to the narrowband PRS period. FIG. 7 shows an example of these embodiments.

In other variants of these embodiments, each PRS frequency hopping configuration includes a plurality of narrowband PRS durations respectively corresponding to the plurality of sub-bands within the PRS bandwidth. The received positioning measurements or information derived therefrom are based on UE measurement of each sub-band for the corresponding narrowband PRS duration. FIG. 8 shows an example of these embodiments.

In some embodiments, the plurality of sub-bands are non-overlapping in frequency. FIGS. 6-9 show examples of these embodiments. In other embodiments, one or more pairs of sub-bands (i.e., among the plurality sub-bands) are partially overlapping in frequency and each PRS frequency hopping configuration also indicates an amount or degree of frequency overlap between partially overlapping pairs of sub-bands. FIGS. 10-11 show examples of these embodiments.

In some embodiments, each PRS frequency hopping configuration includes the narrowband PRS repetitions and the received positioning measurements or information derived therefrom are based on the UE repeating the sequence of sub-band measurements a number of times that corresponds to the narrowband PRS repetitions. FIG. 9 shows an example of these embodiments.

In some embodiments, the exemplary method can also include the operations of block 1340, where the positioning node can determine a location of the UE based on the received positioning measurements or information derived therefrom.

In addition, FIG. 14 shows an exemplary method (e.g., procedure) for a RAN node configured to support positioning of UEs, according to various embodiments of the present disclosure. The exemplary method can be performed by a RAN node (e.g., base station, eNB, gNB, ng-eNB, TRP, etc.) such as described elsewhere herein.

The exemplary method can include the operations of block 1410, where the RAN node can send, to a positioning node associated with the RAN, a configuration for PRS transmitted by the RAN node. The PRS configuration includes a PRS bandwidth and at least one PRS frequency hopping configuration. For example, the positioning node can be an LMF. The exemplary method can also include the operations of block 1420, where the RAN node can transmit narrowband PRS within the PRS bandwidth according to the at least one PRS frequency hopping configuration.

In some embodiments, the PRS configuration includes a PRS resource set comprising a plurality of PRS resources and each PRS resource includes or is associated with a different sequence of narrowband PRS transmitted by the RAN node within the PRS bandwidth. In some of these embodiments, each PRS frequency hopping configuration includes one or more of the following parameters associated with the narrowband PRS:
narrowband PRS frequency hopping pattern within the PRS bandwidth;
narrowband PRS bandwidth;
narrowband PRS period;
narrowband PRS long period;
narrowband PRS repetitions;
narrowband PRS duration;
frequency offset of an initial narrowband PRS of the sequence, relative to the start of the PRS bandwidth; and
frequency offset of two closest neighbor PRS frequencies in frequency domain.
   For example, the frequency offset of the initial narrowband PRS of the sequence can be given in number of physical resource blocks (PRBs) relative to the start PRB of the PRS bandwidth. As another example, the frequency offset of the two closest neighbor PRS frequencies can be given in number of PRBs.

In some embodiments, all PRS resources in the PRS resource set have the same narrowband PRS frequency hopping pattern. FIGS. 6 and 10-11 show examples of these embodiments. In some embodiments, each PRS frequency hopping configuration includes the narrowband PRS frequency hopping pattern, which identifies a plurality of sub-bands within the PRS bandwidth. In such embodiments, the narrowband PRS are transmitted (e.g., in block 1420) in the plurality of sub-bands in a sequence that corresponds to the narrowband PRS frequency hopping pattern.

In some embodiments, each PRS frequency hopping configuration includes the narrowband PRS period, and the narrowband PRS are transmitted in each sub-band for a duration that corresponds to the narrowband PRS period. FIG. 7 shows an example of these embodiments.

In other embodiments, each PRS frequency hopping configuration includes a plurality of narrowband PRS durations respectively corresponding to the plurality of sub-bands within the PRS bandwidth. The narrowband PRS are transmitted in each sub-band for the corresponding narrowband PRS duration. FIG. 8 shows an example of these embodiments.

In some embodiments, the sequential plurality of sub-bands are non-overlapping in frequency. FIGS. 6-9 show examples of these embodiments. In other embodiments, one or more pairs of sub-bands (i.e., among the plurality of sub-bands) are partially overlapping in frequency and the PRS frequency hopping configuration also indicates an amount or degree of frequency overlap between partially overlapping pairs of sub-bands. FIGS. 10-11 show examples of these embodiments.

In some embodiments, each PRS frequency hopping configuration includes the narrowband PRS repetitions and the sequence of transmissions in the plurality of sub-bands is repeated a number of times that corresponds to the narrowband PRS repetitions. In some variants of these embodiments, each PRS frequency hopping configuration includes the narrowband long period. After an initial repetition, each subsequent repetition of the sequence of narrowband PRS transmissions in the plurality of sub-bands starts the narrowband long period after the start of a most recent repetition of the sequence. FIG. 9 shows an example of these embodiments and variants.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

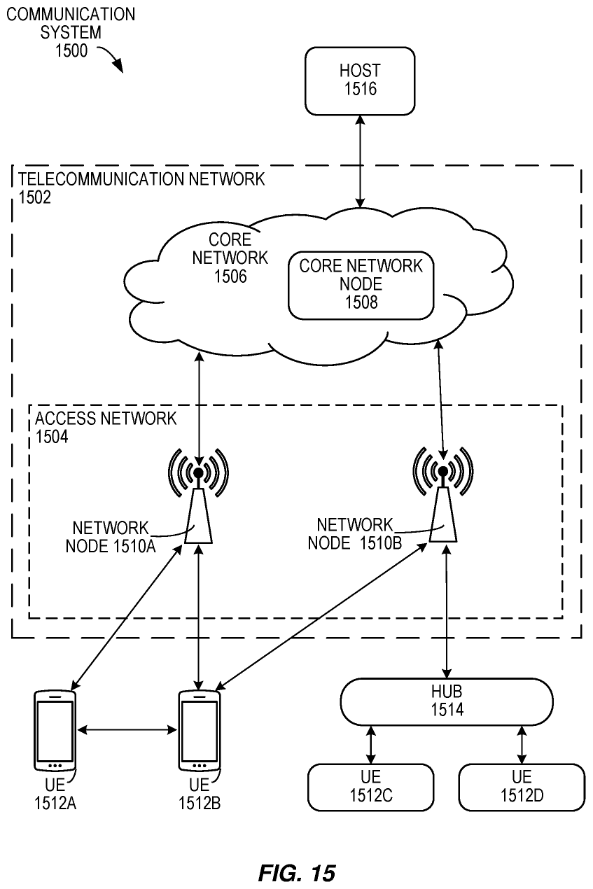

FIG. 15 shows an example of a communication system 1500 in accordance with some embodiments. In this example, communication system 1500 includes a telecommunication network 1502 that includes an access network 1504 (e.g., RAN), and a core network 1506, which includes one or more core network nodes 1508. Access network 1504 includes one or more access network nodes, such as network nodes 1510a-b (one or more of which may be generally referred to as network nodes 1510), or any other similar 3GPP access node or non-3GPP access point. Network nodes 1510 facilitate direct or indirect connection of UEs, such as by connecting UEs 1512a-d (one or more of which may be generally referred to as UEs 1512) to core network 1506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1500 may include any number of wired or wireless networks, network nodes, UEs, and/or any other components or systems that may facilitate or participate in the communication of data and/or signals whether via wired or wireless connections. Communication system 1500 may include and/or interface with any type of communication, telecommunication, data, cellular, radio network, and/or other similar type of system.

UEs 1512 may be any of a wide variety of communication devices, including wireless devices arranged, configured, and/or operable to communicate wirelessly with network nodes 1510 and other communication devices. Similarly, network nodes 1510 are arranged, capable, configured, and/or operable to communicate directly or indirectly with UEs 1512 and/or with other network nodes or equipment in telecommunication network 1502 to enable and/or provide network access, such as wireless network access, and/or to perform other functions, such as administration in telecommunication network 1502.

In the depicted example, core network 1506 connects network nodes 1510 to one or more hosts, such as host 1516. These connections may be direct or indirect via one or more intermediary networks or devices. In other examples, network nodes may be directly coupled to hosts. Core network 1506 includes one or more core network nodes (e.g., core network node 1508) that are structured with hardware and software components. Features of these components may be substantially similar to those described with respect to the UEs, network nodes, and/or hosts, such that the descriptions thereof are generally applicable to the corresponding components of core network node 1508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1516 may be under the ownership or control of a service provider other than an operator or provider of access network 1504 and/or telecommunication network 1502, and may be operated by the service provider or on behalf of the service provider. Host 1516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1500 of FIG. 15 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1502 is a cellular network that implements 3GPP standardized features. Accordingly, telecommunication network 1502 may support network slicing to provide different logical networks to different devices that are connected to telecommunication network 1502. For example, telecommunication network 1502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1512 are configured to transmit and/or receive information without direct human interaction. For instance, a UE may be designed to transmit information to access network 1504 on a predetermined schedule, when triggered by an internal or external event, or in response to requests from access network 1504. Additionally, a UE may be configured for operating in single- or multi-RAT or multi-standard mode. For example, a UE may operate with any one or combination of Wi-Fi, NR (New Radio) and LTE including multi-radio dual connectivity (MR-DC), such as E-UTRAN/NR dual connectivity (EN-DC).

In the example, hub 1514 communicates with access network 1504 to facilitate indirect communication between one or more UEs (e.g., 1512c and/or 1512d) and network nodes (e.g., 1510b). In some examples, hub 1514 may be a controller, router, content source and analytics, or any of the other communication devices described herein regarding UEs. For example, hub 1514 may be a broadband router enabling access to core network 1506 for the UEs. As another example, hub 1514 may be a controller that sends commands or instructions to one or more actuators in the UEs. Hub 1514 can receive commands or instructions from the UEs, network nodes 1510, or by executable code, script, process, or other instructions in hub 1514. As another example, hub 1514 may be a data collector that acts as temporary storage for UE data and, in some embodiments, may perform analysis or other processing of the data. As another example, hub 1514 may be a content source. For example, for a UE that is a VR headset, display, loudspeaker or other media delivery device, hub 1514 may retrieve VR assets, video, audio, or other media or data related to sensory information via a network node, which hub 1514 then provides to the UE either directly, after performing local processing, and/or after adding additional local content. In still another example, hub 1514 acts as a proxy server or orchestrator for the UEs, in particular in if one or more of the UEs are low energy IoT devices.

Hub 1514 may have a constant/persistent or intermittent connection to the network node 1510b. Hub 1514 may also allow for a different communication scheme and/or schedule between hub 1514 and UEs (e.g., UE 1512c and/or 1512d), and between hub 1514 and core network 1506. In other examples, hub 1514 is connected to core network 1506 and/or one or more UEs via a wired connection. Moreover, hub 1514 may be configured to connect to an M2M service provider over access network 1504 and/or to another UE over a direct connection. In some scenarios, UEs may establish a wireless connection with network nodes 1510 while still connected via hub 1514 via a wired or wireless connection. In some embodiments, hub 1514 may be a dedicated hub—that is, a hub whose primary function is to route communications to/from the UEs from/to the network node 1510b. In other embodiments, hub 1514 may be a non-dedicated hub—that is, a device which is capable of operating to route communications between the UEs and network node 1510b, but which is additionally capable of operating as a communication start and/or end point for certain data channels.

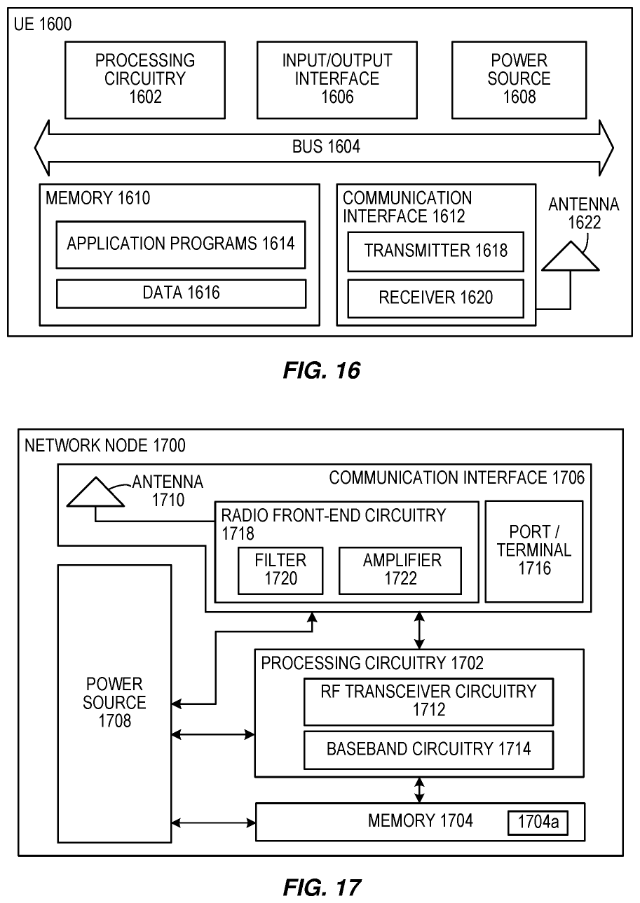

FIG. 16 shows a UE 1600 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1600 includes processing circuitry 1602 that is operatively coupled via a bus 1604 to an input/output interface 1606, a power source 1608, a memory 1610, a communication interface 1612, and/or any other component, or any combination thereof. Certain UEs may utilize all or a subset of the components shown in FIG. 16. The level of integration between the components may vary from one UE to another UE. Further, certain UEs may contain multiple instances of a component, such as multiple processors, memories, transceivers, transmitters, receivers, etc.

Processing circuitry 1602 is configured to process instructions and data and may be configured to implement any sequential state machine operative to execute instructions stored as machine-readable computer programs in memory 1610. Processing circuitry 1602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1602 may include multiple central processing units (CPUs).

In the example, input/output interface 1606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1608 is structured as a battery or battery pack. Other types of power sources, such as an external power source (e.g., an electricity outlet), photovoltaic device, or power cell, may be used. Power source 1608 may further include power circuitry for delivering power from power source 1608 itself, and/or an external power source, to the various parts of UE 1600 via input circuitry or an interface such as an electrical power cable. Delivering power may be, for example, for charging of power source 1608. Power circuitry may perform any formatting, converting, or other modification to the power from power source 1608 to make the power suitable for the respective components of UE 1600 to which power is supplied.

Memory 1610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1610 includes one or more application programs 1614, such as an operating system, web browser application, a widget, gadget engine, or other application, and corresponding data 1616. Memory 1610 may store, for use by UE 1600, any of a variety of various operating systems or combinations of operating systems.

Memory 1610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1610 may allow UE 1600 to access instructions, application programs and the like, stored on transitory or non-transitory memory media, to off-load data, or to upload data. An article of manufacture, such as one utilizing a communication system may be tangibly embodied as or in memory 1610, which may be or comprise a device-readable storage medium.

Processing circuitry 1602 may be configured to communicate with an access network or other network using communication interface 1612. Communication interface 1612 may comprise one or more communication subsystems and may include or be communicatively coupled to an antenna 1622. Communication interface 1612 may include one or more transceivers used to communicate, such as by communicating with one or more remote transceivers of another device capable of wireless communication (e.g., another UE or a network node in an access network). Each transceiver may include a transmitter 1618 and/or a receiver 1620 appropriate to provide network communications (e.g., optical, electrical, frequency allocations, and so forth). Moreover, transmitter 1618 and receiver 1620 may be coupled to one or more antennas (e.g., antenna 1622) and may share circuit components, software or firmware, or alternatively be implemented separately.

In the illustrated embodiment, communication functions of communication interface 1612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1600 shown in FIG. 16.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 17 shows a network node 1700 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1700 includes processing circuitry 1702, memory 1704, communication interface 1706, and power source 1708. Network node 1700 may be composed of multiple physically separate components (e.g., a NodeB component and a RNC component, or a BTS component and a BSC component, etc.), which may each have their own respective components. In certain scenarios in which network node 1700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1700 may be configured to support multiple radio access technologies (RATs). In such embodiments, some components may be duplicated (e.g., separate memory 1704 for different RATs) and some components may be reused (e.g., a same antenna 1710 may be shared by different RATs). Network node 1700 may also include multiple sets of the various illustrated components for different wireless technologies integrated into network node 1700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1700.

Processing circuitry 1702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1700 components, such as memory 1704, to provide network node 1700 functionality.

In some embodiments, processing circuitry 1702 includes a system on a chip (SOC). In some embodiments, processing circuitry 1702 includes one or more of radio frequency (RF) transceiver circuitry 1712 and baseband processing circuitry 1714. In some embodiments, RF transceiver circuitry 1712 and baseband processing circuitry 1714 may be on separate chips (or sets of chips), boards, or units, such as radio units and digital units. In alternative embodiments, part or all of RF transceiver circuitry 1712 and baseband processing circuitry 1714 may be on the same chip or set of chips, boards, or units.

Memory 1704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1702. Memory 1704 may store any suitable instructions, data, or information, including a computer program, software, an application including one or more of logic, rules, code, tables, and/or other instructions (collectively denoted computer program 1704a, which may be a computer program product) capable of being executed by processing circuitry 1702 and utilized by network node 1700. Memory 1704 may be used to store any calculations made by processing circuitry 1702 and/or any data received via communication interface 1706. In some embodiments, processing circuitry 1702 and memory 1704 is integrated.

Communication interface 1706 is used in wired or wireless communication of signaling and/or data between a network node, access network, and/or UE. As illustrated, communication interface 1706 comprises port(s)/terminal(s) 1716 to send and receive data, for example to and from a network over a wired connection. Communication interface 1706 also includes radio front-end circuitry 1718 that may be coupled to, or in certain embodiments a part of, antenna 1710. Radio front-end circuitry 1718 comprises filters 1720 and amplifiers 1722. Radio front-end circuitry 1718 may be connected to an antenna 1710 and processing circuitry 1702. The radio front-end circuitry may be configured to condition signals communicated between antenna 1710 and processing circuitry 1702. Radio front-end circuitry 1718 may receive digital data that is to be sent out to other network nodes or UEs via a wireless connection. Radio front-end circuitry 1718 may convert the digital data into a radio signal having the appropriate channel and bandwidth parameters using a combination of filters 1720 and/or amplifiers 1722. The radio signal may then be transmitted via antenna 1710. Similarly, when receiving data, antenna 1710 may collect radio signals which are then converted into digital data by radio front-end circuitry 1718. The digital data may be passed to processing circuitry 1702. In other embodiments, the communication interface may comprise different components and/or different combinations of components.

In certain alternative embodiments, network node 1700 does not include separate radio front-end circuitry 1718, instead, processing circuitry 1702 includes radio front-end circuitry and is connected to antenna 1710. Similarly, in some embodiments, all or some of the RF transceiver circuitry 1712 is part of communication interface 1706. In still other embodiments, communication interface 1706 includes one or more ports or terminals 1716, radio front-end circuitry 1718, and the RF transceiver circuitry 1712, as part of a radio unit (not shown), and communication interface 1706 communicates with the baseband processing circuitry 1714, which is part of a digital unit (not shown).

Antenna 1710 may include one or more antennas, or antenna arrays, configured to send and/or receive wireless signals. Antenna 1710 may be coupled to radio front-end circuitry 1718 and may be any type of antenna capable of transmitting and receiving data and/or signals wirelessly. In certain embodiments, antenna 1710 is separate from network node 1700 and connectable to network node 1700 through an interface or port.

Antenna 1710, communication interface 1706, and/or processing circuitry 1702 may be configured to perform any receiving operations and/or certain obtaining operations described herein as being performed by the network node. Any information, data and/or signals may be received from a UE, another network node and/or any other network equipment. Similarly, antenna 1710, communication interface 1706, and/or processing circuitry 1702 may be configured to perform any transmitting operations described herein as being performed by the network node. Any information, data and/or signals may be transmitted to a UE, another network node and/or any other network equipment.

Power source 1708 provides power to the various components of network node 1700 in a form suitable for the respective components (e.g., at a voltage and current level needed for each respective component). Power source 1708 may further comprise, or be coupled to, power management circuitry to supply the components of network node 1700 with power for performing the functionality described herein. For example, network node 1700 may be connectable to an external power source (e.g., the power grid, an electricity outlet) via an input circuitry or interface such as an electrical cable, whereby the external power source supplies power to power circuitry of power source 1708. As a further example, power source 1708 may comprise a source of power in the form of a battery or battery pack which is connected to, or integrated in, power circuitry. The battery may provide backup power should the external power source fail.

Embodiments of network node 1700 may include additional components beyond those shown in FIG. 17 for providing certain aspects of the network node's functionality, including any of the functionality described herein and/or any functionality necessary to support the subject matter described herein. For example, network node 1700 may include user interface equipment to allow input of information into network node 1700 and to allow output of information from network node 1700. This may allow a user to perform diagnostic, maintenance, repair, and other administrative functions for network node 1700.

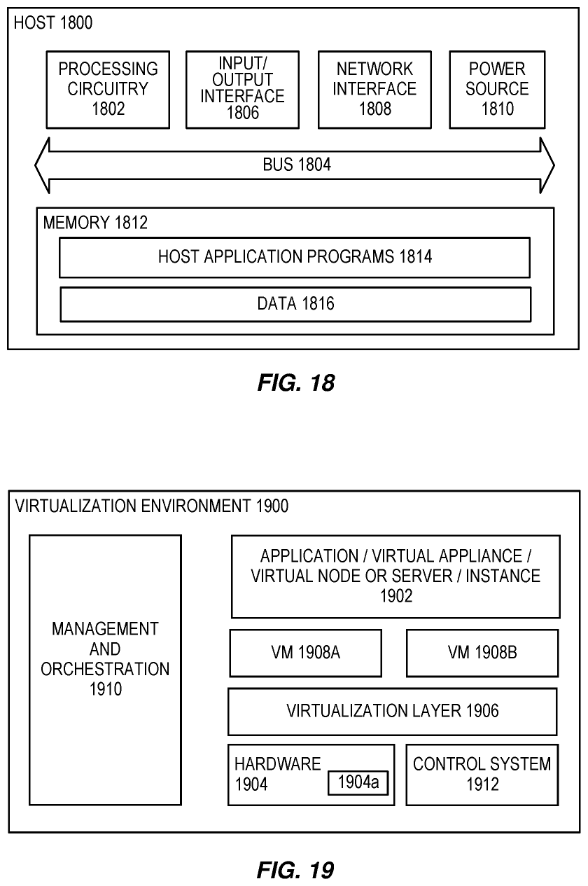

FIG. 18 is a block diagram of a host 1800, which may be an embodiment of host 1516 of FIG. 15, in accordance with various aspects described herein. As used herein, host 1800 may be or comprise various combinations hardware and/or software, including a standalone server, a blade server, a cloud-implemented server, a distributed server, a virtual machine, container, or processing resources in a server farm. Host 1800 may provide one or more services to one or more UEs.

Host 1800 includes processing circuitry 1802 that is operatively coupled via a bus 1804 to an input/output interface 1806, a network interface 1808, a power source 1810, and a memory 1812. Other components may be included in other embodiments. Features of these components may be substantially similar to those described with respect to the devices of previous figures, such as FIGS. 16 and 17, such that the descriptions thereof are generally applicable to the corresponding components of host 1800.

Memory 1812 may include one or more computer programs including one or more host application programs 1814 and data 1816, which may include user data, e.g., data generated by a UE for host 1800 or data generated by host 1800 for a UE. Embodiments of host 1800 may utilize only a subset or all of the components shown. Host application programs 1814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1814 may also provide for user authentication and licensing checks and may periodically report health, routes, and content availability to a central node, such as a device in or on the edge of a core network. Accordingly, host 1800 may select and/or indicate a different host for over-the-top services for a UE. Host application programs 1814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 19 is a block diagram illustrating a virtualization environment 1900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1902 (which may alternatively be called software instances, virtual appliances, network functions, virtual nodes, virtual network functions, etc.) are run in the virtualization environment 1900 to implement some of the features, functions, and/or benefits of some of the embodiments disclosed herein.

Hardware 1904 includes processing circuitry, memory that stores software and/or instructions (collectively denoted computer program product 1904a) executable by hardware processing circuitry, and/or other hardware devices as described herein, such as a network interface, input/output interface, and so forth. Software may be executed by the processing circuitry to instantiate one or more virtualization layers 1906 (also referred to as hypervisors or virtual machine monitors (VMMs)), provide VMs 1908a-b (one or more of which may be generally referred to as VMs 1908), and/or perform any of the functions, features and/or benefits described in relation with some embodiments described herein. The virtualization layer 1906 may present a virtual operating platform that appears like networking hardware to the VMs 1908.

VMs 1908 comprise virtual processing, virtual memory, virtual networking or interface and virtual storage, and may be run by a corresponding virtualization layer 1906. Different embodiments of the instance of a virtual appliance 1902 may be implemented on one or more of VMs 1908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1908 may be a software implementation of a physical machine that runs programs as if they were executing on a physical, non-virtualized machine. Each VM 1908, and that part of hardware 1904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1908 on top of the hardware 1904 and corresponds to the application 1902.

Hardware 1904 may be implemented in a standalone network node with generic or specific components. Hardware 1904 may implement some functions via virtualization. Alternatively, hardware 1904 may be part of a larger cluster of hardware (e.g., in a data center or CPE) where many hardware nodes work together and are managed via management and orchestration 1910, which, among others, oversees lifecycle management of applications 1902. In some embodiments, hardware 1904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1912 which may alternatively be used for communication between hardware nodes and radio units.

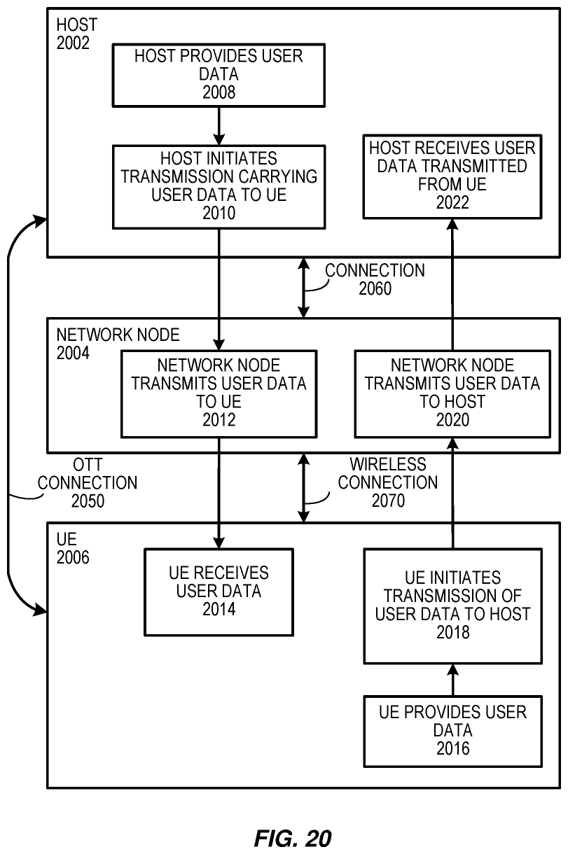

FIG. 20 shows a communication diagram of a host 2002 communicating via a network node 2004 with a UE 2006 over a partially wireless connection in accordance with some embodiments. Example implementations, in accordance with various embodiments, of the UE (such as a UE 1512a of FIG. 15 and/or UE 1600 of FIG. 16), network node (such as network node 1510a of FIG. 15 and/or network node 1700 of FIG. 17), and host (such as host 1516 of FIG. 15 and/or host 1800 of FIG. 18) discussed in the preceding paragraphs will now be described with reference to FIG. 20.

Like host 1800, embodiments of host 2002 include hardware, such as a communication interface, processing circuitry, and memory. Host 2002 also includes software, which is stored in or accessible by host 2002 and executable by the processing circuitry. The software includes a host application that may be operable to provide a service to a remote user, such as UE 2006 connecting via an over-the-top (OTT) connection 2050 extending between UE 2006 and host 2002. In providing the service to the remote user, a host application may provide user data which is transmitted using OTT connection 2050.

Network node 2004 includes hardware enabling it to communicate with host 2002 and UE 2006. Connection 2060 may be direct or pass through a core network (like core network 1506 of FIG. 15) and/or one or more other intermediate networks, such as one or more public, private, or hosted networks. For example, an intermediate network may be a backbone network or the Internet.

UE 2006 includes hardware and software, which is stored in or accessible by UE 2006 and executable by the UE's processing circuitry. The software includes a client application, such as a web browser or operator-specific “app” that may be operable to provide a service to a human or non-human user via UE 2006 with the support of host 2002. In host 2002, an executing host application may communicate with the executing client application via OTT connection 2050 terminating at UE 2006 and host 2002. In providing the service to the user, the UE's client application may receive request data from the host's host application and provide user data in response to the request data. OTT connection 2050 may transfer both the request data and the user data. The UE's client application may interact with the user to generate the user data that it provides to the host application through OTT connection 2050.

OTT connection 2050 may extend via a connection 2060 between host 2002 and network node 2004 and via a wireless connection 2070 between network node 2004 and UE 2006 to provide the connection between host 2002 and UE 2006. Connection 2060 and wireless connection 2070, over which OTT connection 2050 may be provided, have been drawn abstractly to illustrate the communication between host 2002 and UE 2006 via network node 2004, without explicit reference to any intermediary devices and the precise routing of messages via these devices.

As an example of transmitting data via OTT connection 2050, in step 2008, host 2002 provides user data, which may be performed by executing a host application. In some embodiments, the user data is associated with a particular human user interacting with UE 2006. In other embodiments, the user data is associated with a UE 2006 that shares data with host 2002 without explicit human interaction. In step 2010, host 2002 initiates a transmission carrying the user data towards UE 2006. Host 2002 may initiate the transmission responsive to a request transmitted by UE 2006. The request may be caused by human interaction with UE 2006 or by operation of the client application executing on UE 2006. The transmission may pass via network node 2004, in accordance with the teachings of the embodiments described throughout this disclosure. Accordingly, in step 2012, network node 2004 transmits to UE 2006 the user data that was carried in the transmission that host 2002 initiated, in accordance with the teachings of the embodiments described throughout this disclosure. In step 2014, UE 2006 receives the user data carried in the transmission, which may be performed by a client application executed on UE 2006 associated with the host application executed by host 2002.

In some examples, UE 2006 executes a client application which provides user data to host 2002. The user data may be provided in reaction or response to the data received from host 2002. Accordingly, in step 2016, UE 2006 may provide user data, which may be performed by executing the client application. In providing the user data, the client application may further consider user input received from the user via an input/output interface of UE 2006. Regardless of the specific manner in which the user data was provided, UE 2006 initiates, in step 2018, transmission of the user data towards host 2002 via network node 2004. In step 2020, in accordance with the teachings of the embodiments described throughout this disclosure, network node 2004 receives user data from UE 2006 and initiates transmission of the received user data towards host 2002. In step 2022, host 2002 receives the user data carried in the transmission initiated by UE 2006.

One or more of the various embodiments improve the performance of OTT services provided to UE 2006 using OTT connection 2050, in which wireless connection 2070 forms the last segment. More precisely, embodiments described herein provide flexible and efficient techniques that can reduce PRS implementation complexity for both UE and network. Embodiments can also reduce PRS-related signaling between positioning node and RAN nodes, between positioning node and UEs, and/or between RAN nodes and their associated TRPs that transmit PRS. At a high level, embodiments facilitate improved positioning based on frequency hopped PRS, which is beneficial to combat fading often experienced on wireless channels. In this manner, embodiments can improve the delivery of positioning-based OTT services by a wireless network, which increases the value of such services to end users and OTT service providers.

In an example scenario, factory status information may be collected and analyzed by host 2002. As another example, host 2002 may process audio and video data which may have been retrieved from a UE for use in creating maps. As another example, host 2002 may collect and analyze real-time data to assist in controlling vehicle congestion (e.g., controlling traffic lights). As another example, host 2002 may store surveillance video uploaded by a UE. As another example, host 2002 may store or control access to media content such as video, audio, VR or AR which it can broadcast, multicast or unicast to UEs. As other examples, host 2002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 2050 between host 2002 and UE 2006, in response to variations in the measurement results. The measurement procedure and/or the network functionality for reconfiguring the OTT connection may be implemented in software and hardware of host 2002 and/or UE 2006. In some embodiments, sensors (not shown) may be deployed in or in association with other devices through which OTT connection 2050 passes; the sensors may participate in the measurement procedure by supplying values of the monitored quantities exemplified above, or supplying values of other physical quantities from which software may compute or estimate the monitored quantities. The reconfiguring of OTT connection 2050 may include message format, retransmission settings, preferred routing etc.; the reconfiguring need not directly alter the operation of network node 2004. Such procedures and functionalities may be known and practiced in the art. In certain embodiments, measurements may involve proprietary UE signaling that facilitates measurements of throughput, propagation times, latency and the like, by host 2002. The measurements may be implemented in that software causes messages to be transmitted, in particular empty or ‘dummy’ messages, using OTT connection 2050 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:

A1. A method for a user equipment (UE) configured for positioning in a radio access network (RAN), the method comprising:
receiving, from a positioning node associated with the RAN, a plurality of configurations for positioning reference signals (PRS) transmitted by a corresponding plurality of RAN nodes, wherein each PRS configuration includes a PRS bandwidth and at least one PRS frequency hopping configuration;
for each RAN node, performing positioning measurements on narrowband PRS transmitted by the RAN node within the PRS bandwidth according to the at least one PRS frequency hopping configuration; and
sending the positioning measurements, or information derived therefrom, to the positioning node.
   A2. The method of embodiment A1, wherein:
each PRS configuration includes a PRS resource set comprising a plurality of PRS resources;
each PRS resource includes or is associated with a different sequence of narrowband PRS transmitted by the RAN node within the PRS bandwidth; and
the positioning measurements are performed on the PRS resources.
   A3. The method of embodiment A2, wherein each PRS frequency hopping configuration includes one or more of the following parameters associated with the narrowband PRS:
narrowband PRS frequency hopping pattern within the PRS bandwidth;
narrowband PRS bandwidth;
narrowband PRS period;
narrowband PRS long period;
narrowband PRS repetitions;
narrowband PRS duration; and
frequency offset of initial narrowband PRS of the sequence, relative to the start of the PRS bandwidth.
   A4. The method of embodiment A3, wherein all PRS resources in the PRS resource set have the same narrowband PRS frequency hopping pattern.
   A5. The method of any of embodiments A3-A4, wherein:
each PRS frequency hopping configuration includes the narrowband PRS frequency hopping pattern, which identifies a sequential plurality of sub-bands within the PRS bandwidth; and
performing the positioning measurements comprises measuring individual sub-bands in a sequence that corresponds to the narrowband PRS frequency hopping pattern.
   A6. The method of embodiment A5, wherein:
each PRS frequency hopping configuration includes the narrowband PRS period, and
each individual sub-band is measured for a duration that corresponds to the narrowband PRS period.
   A7. The method of embodiment A5, wherein:
each PRS frequency hopping configuration includes a plurality of narrowband PRS durations associated with a corresponding plurality of sub-bands within the PRS bandwidth; and
each individual sub-band is measured for corresponding narrowband PRS duration.
   A8. The method of any of embodiments A5-A7, wherein one of the following applies:
the sequential plurality of sub-bands are non-overlapping in frequency; or
one or more pairs of the sub-bands are partially overlapping in frequency and each PRS frequency hopping configuration also indicates an amount or degree of frequency overlap between partially overlapping pairs.
   A9. The method of any of embodiments A5-A8, wherein:
each PRS frequency hopping configuration includes the narrowband PRS repetitions; and
the sequence of individual sub-band measurements is repeated a number of times that corresponds to the narrowband PRS repetitions.
   A10. The method of embodiment A9, wherein:
each PRS frequency hopping configuration includes the narrowband long period; and
after an initial repetition, each subsequent repetition of the sequence of individual sub-band measurements starts the narrowband long period after the start of a most recent repetition.
   B1. A method for a positioning node associated with a radio access network (RAN), the method comprising:
receiving, from a plurality of RAN nodes, a plurality of configurations for positioning reference signals (PRS) transmitted by the respective RAN nodes, wherein each PRS configuration includes a PRS bandwidth and at least one PRS frequency hopping configuration;
sending the plurality of PRS configurations to a user equipment (UE) served by one of the RAN nodes; and
receiving from the UE positioning measurements performed by the UE or information derived therefrom, wherein the positioning measurements are of narrowband PRS transmitted by the plurality of RAN nodes within the respective PRS bandwidths according to the respective PRS frequency hopping configurations.
   B2. The method of embodiment B1, wherein
each PRS configuration includes a PRS resource set comprising a plurality of PRS resources;
each PRS resource includes or is associated with a different sequence of narrowband PRS transmitted by the RAN node within the PRS bandwidth; and
the positioning measurements are performed by the UE on the PRS resources.
   B3. The method of embodiment B2, wherein each PRS frequency hopping configuration includes one or more of the following parameters associated with the narrowband PRS:
narrowband PRS frequency hopping pattern within the PRS bandwidth;
narrowband PRS bandwidth;
narrowband PRS period;
narrowband PRS long period;
narrowband PRS repetitions;
narrowband PRS duration; and
frequency offset of initial narrowband PRS of the sequence, relative to the start of the PRS bandwidth.
   B4. The method of embodiment B3, wherein all PRS resources in the PRS resource set have the same narrowband PRS frequency hopping pattern.
   B5. The method of any of embodiments B3-B4, wherein:
each PRS frequency hopping configuration includes the narrowband PRS frequency hopping pattern, which identifies a sequential plurality of sub-bands within the PRS bandwidth; and
the received positioning measurements or information derived therefrom are based on UE measurements of individual sub-bands in a sequence that corresponds to the narrowband PRS frequency hopping pattern.
   B6. The method of embodiment B5, wherein:
each PRS frequency hopping configuration includes the narrowband PRS period, and
the received positioning measurements or information derived therefrom are based on UE measurement of each individual sub-band for a duration that corresponds to the narrowband PRS period.
   B7. The method of embodiment B5, wherein:
each PRS frequency hopping configuration includes a plurality of narrowband PRS durations associated with a corresponding plurality of sub-bands within the PRS bandwidth; and
the received positioning measurements or information derived therefrom are based on UE measurement of each individual sub-band for the corresponding narrowband PRS duration.
   B8. The method of any of embodiments B5-B7, wherein one of the following applies:
the sequential plurality of sub-bands are non-overlapping in frequency; or
one or more pairs of the sub-bands are partially overlapping in frequency and each PRS frequency hopping configuration also indicates an amount or degree of frequency overlap between partially overlapping pairs.
   B9. The method of any of embodiments B5-B8, wherein:
each PRS frequency hopping configuration includes the narrowband PRS repetitions; and
the received positioning measurements or information derived therefrom are based on UE repetition of the sequence of individual sub-band measurements a number of times that corresponds to the narrowband PRS repetitions.
   B10. The method of any of embodiments B1-B9, further comprising determining a location of the UE based on the received positioning measurements or information derived therefrom.
   C1. A method for a radio access network (RAN) node configured to support positioning of user equipment (UEs), the method comprising:
sending, to a positioning node, a configuration for positioning reference signals (PRS) transmitted by the RAN node, wherein the PRS configuration includes a PRS bandwidth and at least one PRS frequency hopping configuration; and
transmitting narrowband PRS within the PRS bandwidth according to the at least one PRS frequency hopping configuration.
   C2. The method of embodiment C1, wherein:
the PRS configuration includes a PRS resource set comprising a plurality of PRS resources; and
each PRS resource includes or is associated with a different sequence of narrowband PRS transmitted by the RAN node within the PRS bandwidth.
   C3. The method of embodiment C2, wherein each PRS frequency hopping configuration includes one or more of the following parameters associated with the narrowband PRS:
narrowband PRS frequency hopping pattern within the PRS bandwidth;
narrowband PRS bandwidth;
narrowband PRS period;
narrowband PRS long period;
narrowband PRS repetitions;
narrowband PRS duration; and
frequency offset of initial narrowband PRS of the sequence, relative to the start of the PRS bandwidth.
   C4. The method of embodiment C3, wherein all PRS resources in the PRS resource set have the same narrowband PRS frequency hopping pattern.
   C5. The method of any of embodiments C3-C4, wherein:
the PRS frequency hopping configuration includes the narrowband PRS frequency hopping pattern, which identifies a sequential plurality of sub-bands within the PRS bandwidth; and
the narrowband PRS are transmitted in individual sub-bands in a sequence that corresponds to the narrowband PRS frequency hopping pattern.
   C6. The method of embodiment C5, wherein:
the PRS frequency hopping configuration includes the narrowband PRS period, and
the narrowband PRS are transmitted in each individual sub-band for a duration that corresponds to the narrowband PRS period.
   C7. The method of embodiment C5, wherein:
the PRS frequency hopping configuration includes a plurality of narrowband PRS durations associated with a corresponding plurality of sub-bands within the PRS bandwidth; and
the narrowband PRS are transmitted in each individual sub-band for the corresponding narrowband PRS duration.
   C8. The method of any of embodiments C5-C7, wherein one of the following applies:
the sequential plurality of sub-bands are non-overlapping in frequency; or
one or more pairs of the sub-bands are partially overlapping in frequency and the PRS frequency hopping configuration also indicates an amount or degree of frequency overlap between partially overlapping pairs.
   C9. The method of any of embodiments C5-C8, wherein:
each PRS frequency hopping configuration includes the narrowband PRS repetitions; and
the sequence of transmissions in individual sub-bands is repeated a number of times that corresponds to the narrowband PRS repetitions.
   C10. The method of embodiment C9, wherein:
each PRS frequency hopping configuration includes the narrowband long period; and
after an initial repetition, each subsequent repetition of the sequence of transmissions in individual sub-bands starts the narrowband long period after the start of a most recent repetition.
   D1. A user equipment (UE) configured for positioning in a radio access network (RAN), the UE comprising:
communication interface circuitry configured to communicate with RAN nodes and with a positioning node associated with the RAN; and
processing circuitry operatively coupled to the communication interface circuitry, whereby the processing circuitry and the communication interface circuitry are configured to perform operations corresponding to any of the methods of embodiments A1-A10.
   D2. A user equipment (UE) configured for positioning in a radio access network (RAN), the UE being further configured to perform operations corresponding to any of the methods of embodiments A1-A10.
   D3. A non-transitory, computer-readable medium storing computer-executable instructions that, when executed by processing circuitry of a user equipment (UE) configured for positioning in a radio access network (RAN), configure the UE to perform operations corresponding to any of the methods of embodiments A1-A10.
   D4. A computer program product comprising computer-executable instructions that, when executed by processing circuitry of a user equipment (UE) configured for positioning in a radio access network (RAN), configure the UE to perform operations corresponding to any of the methods of embodiments A1-A10.
   E1. A positioning node configured to operate with a radio access network (RAN), the positioning node comprising:
communication interface circuitry configured to communicate with RAN nodes and with user equipment (UEs) operating in the RAN; and
processing circuitry operatively coupled to the communication interface circuitry, whereby the processing circuitry and the communication interface circuitry are configured to perform operations corresponding to any of the methods of embodiments B1-B10.
   E2. A positioning node configured to operate with a radio access network (RAN), the positioning node being further configured to perform operations corresponding to any of the methods of embodiments B1-B10.
   E3. A non-transitory, computer-readable medium storing computer-executable instructions that, when executed by processing circuitry of a positioning node configured to operate with a radio access network (RAN), configure the positioning node to perform operations corresponding to any of the methods of embodiments B1-B10.
   E4. A computer program product comprising computer-executable instructions that, when executed by processing circuitry of a positioning node configured to operate with a radio access network (RAN), configure the positioning node to perform operations corresponding to any of the methods of embodiments B1-B10.
   F1. A radio access network (RAN) configured to support positioning of user equipment (UEs), the RAN node comprising:
communication interface circuitry configured to communicate with UEs and with a positioning node associated with the RAN; and
processing circuitry operatively coupled to the communication interface circuitry, whereby the processing circuitry and the communication interface circuitry are configured to perform operations corresponding to any of the methods of embodiments C1-C10.
   F2. A radio access network (RAN) configured to support positioning of user equipment (UEs), the RAN node being configured to perform operations corresponding to any of the methods of embodiments C1-C10.
   F3. A non-transitory, computer-readable medium storing computer-executable instructions that, when executed by processing circuitry of a radio access network (RAN) configured to support positioning of user equipment (UEs), configure the RAN node to perform operations corresponding to any of the methods of embodiments C1-C10.
   F4. A computer program product comprising computer-executable instructions that, when executed by processing circuitry of a radio access network (RAN) configured to support positioning of user equipment (UEs), configure the RAN node to perform operations corresponding to any of the methods of embodiments C1-C10.

1.-51. (canceled)

52. A method for a user equipment (UE) configured for positioning in a radio access network (RAN), the method comprising:
receiving, from a positioning node associated with the RAN, a plurality of configurations for positioning reference signals (PRS) to be transmitted by a corresponding plurality of RAN nodes, wherein:
each PRS configuration comprises a PRS resource set associated with at least one PRS frequency hopping configuration, and
one or more of the at least one PRS frequency hopping configuration is for partially overlapping PRS frequencies within a PRS bandwidth;
for each of the RAN node of the plurality of RAN nodes, performing positioning measurements on narrowband PRSs transmitted by the RAN node according to the at least one PRS frequency hopping configuration; and
sending, to the positioning node, the positioning measurements or information derived from the positioning measurements.

53. The method of claim 52, wherein:
each of the at least one PRS frequency hopping configuration comprises a narrowband PRS frequency hopping pattern; and
each PRS resource set comprises a plurality of PRS resources that have a same narrowband PRS frequency hopping pattern or different narrowband PRS frequency hopping patterns.

54. The method of claim 53, wherein each of the at least one PRS frequency hopping configuration further comprises one or more of the following parameters associated with the narrowband PRSs:
narrowband PRS bandwidth;
narrowband PRS period;
narrowband PRS long period;
narrowband PRS repetitions; and
narrowband PRS duration.

55. The method of claim 54, wherein:
each PRS frequency hopping configuration includes a plurality of narrowband PRS durations respectively corresponding to a plurality of sub-bands within the PRS bandwidth; and
each sub-band on which the narrowband PRSs are transmitted is measured for the corresponding narrowband PRS duration.

56. The method of claim 52, wherein each of the one or more PRS frequency hopping configurations for partially overlapping PRS frequencies comprises at least one of the following parameters:
frequency offset of two closest neighbor PRS frequencies on which the narrowband PRSs are transmitted; and
frequency offset of an initial narrowband PRS relative to a start PRB of the PRS bandwidth.

57. The method of claim 56, wherein one or more of the following applies:
the frequency offset of the initial narrowband PRS is given in number of physical resource blocks (PRBs) relative to the start PRB of the PRS bandwidth; and
the frequency offset of the two closest neighbor PRS frequencies is given in number of PRBs.

58. A method for a positioning node associated with a radio access network, RAN, the method comprising:
receiving, from a plurality of RAN nodes, a plurality of configurations for positioning reference signals, PRS, to be transmitted by the respective RAN nodes, wherein:
each PRS configuration comprises a PRS resource set associated with at least one PRS frequency hopping configuration, and
one or more of the at least one PRS frequency hopping configuration is for partially overlapping PRS frequencies within a PRS bandwidth
sending the plurality of PRS configurations to a user equipment (UE) served by one of the RAN nodes; and
receiving one of the following from the UE:
positioning measurements performed by the UE on narrowband PRSs transmitted by the plurality of RAN nodes according to the respective PRS frequency hopping configurations, or
information derived from the positioning measurements performed by the UE.

59. The method of claim 58, wherein
each of the at least one PRS frequency hopping configuration comprises a narrowband PRS frequency hopping pattern; and
each PRS resource set comprises a plurality of PRS resources that have a same narrowband PRS frequency hopping pattern or different narrowband PRS frequency hopping patterns.

60. The method of claim 59, wherein each of the at least one PRS frequency hopping configuration further comprises one or more of the following parameters associated with the narrowband PRSs:
narrowband PRS bandwidth;
narrowband PRS period;
narrowband PRS long period;
narrowband PRS repetitions; and
narrowband PRS duration.

61. The method of claim 60, wherein:
each PRS frequency hopping configuration includes a plurality of narrowband PRS durations respectively corresponding to a plurality of sub-bands within the PRS bandwidth; and
each sub-band on which the narrowband PRSs are transmitted is measured for the corresponding narrowband PRS duration.

62. The method of claim 58, wherein each of the one or more PRS frequency hopping configurations for partially overlapping PRS frequencies comprises at least one of the following parameters:
frequency offset of two closest neighbor PRS frequencies on which the narrowband PRSs are transmitted; and
frequency offset of an initial narrowband PRS relative to a start PRB of the PRS bandwidth.

63. The method of claim 62, wherein one or more of the following applies:
the frequency offset of the initial narrowband PRS is given in number of physical resource blocks (PRBs) relative to the start PRB of the PRS bandwidth; and
the frequency offset of the two closest neighbor PRS frequencies is given in number of PRBs.

64. A method for a radio access network (RAN) node configured to facilitate positioning of user equipment (UEs), the method comprising:
sending, to a positioning node associated with the RAN, a configuration for positioning reference signals (PRS) to be transmitted by the RAN node, wherein:
the PRS configuration comprises a PRS resource set associated with at least one PRS frequency hopping configuration, and
one or more of the at least one PRS frequency hopping configuration is for partially overlapping PRS frequencies within a PRS bandwidth; and
transmitting narrowband PRSs according to the at least one PRS frequency hopping configuration.

65. The method of claim 64, wherein:
each of the at least one PRS frequency hopping configuration comprises a narrowband PRS frequency hopping pattern; and
each PRS resource set comprises a plurality of PRS resources that have a same narrowband PRS frequency hopping pattern or different narrowband PRS frequency hopping patterns.

66. The method of claim 65, wherein each of the at least one PRS frequency hopping configuration further comprises one or more of the following parameters associated with the narrowband PRSs:
narrowband PRS bandwidth;
narrowband PRS period;
narrowband PRS long period;
narrowband PRS repetitions; and
narrowband PRS duration.

67. The method of claim 64, wherein each of the one or more PRS frequency hopping configurations for partially overlapping PRS frequencies comprises at least one of the following parameters:
frequency offset of an initial narrowband PRS relative to a start PRB of the PRS bandwidth; and
frequency offset of two closest neighbor PRS frequencies on which the narrowband PRSs are transmitted.

68. The method of claim 67, wherein one or more of the following applies:
the frequency offset of the initial narrowband PRS is given in number of physical resource blocks (PRBs) relative to the start PRB of the PRS bandwidth; and
the frequency offset of the two closest neighbor PRS frequencies is given in number of PRBs.

69. A user equipment (UE) configured for positioning in a radio access network (RAN), the UE comprising:
communication interface circuitry configured to communicate with RAN nodes and with a positioning node associated with the RAN; and
processing circuitry operatively coupled to the communication interface circuitry, wherein the processing circuitry and the communication interface circuitry are configured to perform the method of claim 52.

70. A positioning node configured to operate with a radio access network (RAN), the positioning node comprising:
communication interface circuitry configured to communicate with RAN nodes and with user equipment (UEs) operating in the RAN; and
processing circuitry operatively coupled to the communication interface circuitry, wherein the processing circuitry and the communication interface circuitry are configured to perform the method of claim 58.

71. A radio access network (RAN) node configured to facilitate positioning of user equipment (UEs), the RAN node comprising:
communication interface circuitry (configured to communicate with UEs and with a positioning node associated with the RAN; and
processing circuitry operatively coupled to the communication interface circuitry, wherein the processing circuitry and the communication interface circuitry are configured to perform the method of claim 64.
